(19) United States
(12) Patent Application Publication
(10) Pub. No.: US 2020/0103426 A1
(43) Pub. Date: Apr. 2, 2020

(54) ANALYZER AND METHOD FOR TESTING A SAMPLE

(71) Applicant: BOEHRINGER INGELHEIM VETMEDICA GMBH, Ingelheim am Rhein (DE)

(72) Inventors: Axel NIEMEYER, Bielefeld (DE); Guenter BRUCKMANN, Wuerselen (DE); Bernhard BENDER, Herzogenrath (DE)

(73) Assignee: BOEHRINGER INGELHEIM VETMEDICA GMBH, Ingelheim am Rhein (DE)

(21) Appl. No.: 16/586,064

(22) Filed: Sep. 27, 2019

(30) Foreign Application Priority Data
Oct. 1, 2018 (EP) 18197971.7

(51) Int. Cl. G01N 35/00; B01L 3/00

(52) U.S. Cl. CPC G01N 35/00623; B01L 3/502769; B01L 2400/0666; B01L 2300/0816; B01L 2300/0883; B01L 2300/0627

(57) ABSTRACT

An analyzer for testing a biological sample is proposed, wherein the analyzer comprises a pressurized gas supply having an intermediate gas storage that is fluidically arranged between an intermediate valve and an actuation valve. A method for testing a biological sample is proposed, wherein the power supply of an intermediate valve is cut off when the valve starts to change its position and/or wherein the pressure of an intermediate gas storage located downstream of an intermediate valve is controlled. Further, a method for inspecting an analyzer, in particular its pressurized gas supply, is proposed, wherein the pressure drop in a main gas storage is measured and compared to a reference pressure drop in order to inspect the analyzer.

### BACKGROUND OF THE INVENTION

### Field of the Invention

The present invention relates to an analyzer, a method for testing a sample and a method for inspecting an analyzer.

Preferably, the present invention deals with analyzing and testing a preferably biological sample, in particular from a human or animal, mostly preferred for analytics and diagnostics, e.g. with regard to the presence of diseases and/or pathogens and/or for determining blood counts, antibodies, hormones, steroids or the like.

Therefore, the present invention is in particular within the field of bioanalytics. A food sample, environmental sample or another sample may optionally also be tested, in particular for environmental analytics or food safety and/or for detecting other substances.

Preferably, by means of the present invention, at least one analyte (target analyte) of a sample can be determined, identified or detected. In particular, the sample can be tested for qualitatively or quantitatively determining at least one analyte, e.g. in order to detect or identify a disease and/or pathogen.

Within the meaning of the present invention, analytes are in particular nucleic-acid sequences, in particular DNA sequences and/or RNA sequences, and/or proteins, in particular antigens and/or antibodies. In particular, by means of the present invention, nucleic-acid sequences or proteins can be determined, identified or detected as the analytes of a sample. Mostly preferred, the present invention deals with systems, devices and other apparatuses for carrying out a nucleic-acid assay for detecting or identifying a nucleic-acid sequence or a protein assay for detecting or identifying a protein.

The present invention deals in particular with what are known as point-of-care systems, e.g. mobile systems/devices and other mobile apparatuses, and deals with methods for carrying out tests on a sample at the sampling site and/or independently or away from a central laboratory or the like. Preferably, point-of-care systems can be operated autonomously and/or independently of a mains network for supplying electrical power.

### Description of the Related Art

U.S. Pat. No. 5,096,669 discloses a point-of-care system for testing a biological sample, in particular a blood sample. The system comprises a single-use cartridge and an analyzer. Once the sample has been received, the cartridge is inserted into the analyzer in order to carry out the test. The cartridge comprises a microfluidic system and a sensor apparatus comprising electrodes, which apparatus is calibrated by means of a calibration liquid and is then used to test the sample.

Furthermore, International Patent Application Publication WO 2006/125767 A1 and corresponding U.S. Pat. No. 9,110,044 B2 disclose a point-of-care system for integrated and automated DNA or protein analysis, comprising a single-use cartridge and an analyzer for fully automatically processing and evaluating molecular-diagnostic analyses using the single-use cartridge.

In point-of-care systems, it is important that the analyzers used are constructed in a simple and robust manner, that the analyzers used have a low energy consumption and that the test can be conducted in a simple, reliable and fast manner.

### SUMMARY OF THE INVENTION

The object of the present invention is to provide an improved analyzer for testing a sample and an improved method for testing a sample, preferably having a low energy consumption and/or wherein a simple, cost-effective and/or low maintenance construction and/or a simple, reliable and/or fast conduction of the test is possible, facilitated or achieved.

The problem is solved by an analyzer according to claim 1, a method according to claim 12 or a method according to claim 19. Advantage developments are subject of the dependent claims.

The proposed analyzer preferably comprises a pressurized/compressed gas supply for providing a pressurized/compressed gas, in particular air, wherein the pressurized gas supply comprises a preferably electrically driven compressor, a main gas storage downstream of the compressor, an intermediate valve downstream of the main gas storage and at least one actuation valve downstream of the intermediate valve.

According to one aspect of the present invention, the analyzer comprises—in particular additionally to the main gas storage—an intermediate gas storage that is fluidically arranged downstream of the main gas storage and/or between the intermediate valve and the actuation valve.

The main gas storage and/or the intermediate gas storage are/is preferably embodied as a tank/container/reservoir, preferably wherein the main gas storage and the intermediate gas storage are fluidically connected or connectable to one another, in particular by means of at least one pneumatic line.

The volume of the main gas storage is preferably larger than the volume of the intermediate gas storage, preferably by a factor of at least 2 or 3, in particular by at least 5 or 10.

Due to the intermediate gas storage, it is possible to control the pressure independently from the main gas storage and/or without changing the pressure in the main gas storage. In particular, it is possible to adapt the pressure in the intermediate gas storage according to the load needed, preferably independently of the main gas storage and/or without adapting the pressure in the main gas storage.

Thus, such a construction/arrangement allows a flexible, dynamic and/or highly responsive supply with pressurized gas.

Preferably, the analyzer comprises a plurality of actuation valves, each preferably being associated/assigned to different apparatuses for controlling the fluid flow in the cartridge.

In particular, the pressure of the intermediate gas storage can be adapted dependent on load required, i.e. the apparatus of the plurality of apparatuses to be activated/deactivated and/or used.

The analyzer, in particular the pressurized gas supply, preferably comprises an intermediate pressure sensor for measuring the pressure in the intermediate gas storage, a main pressure sensor for measuring the pressure in the main gas storage and/or a control apparatus for controlling/adapting the pressure in the main gas storage and/or intermediate gas storage.

The control apparatus is preferably electrically connected to the intermediate pressure sensor, the main pressure sensor, the intermediate valve and/or the actuation valve(s), in particular in order to control the pressure of the intermediate gas storage.

According to the proposed method for testing an in particular biological sample in an analyzer by means of a cartridge, at least one apparatus for controlling the fluid flow in the cartridge, in particular a pump apparatus and/or a sensor apparatus of the cartridge, is pneumatically operated/powered and/or supplied with pressurized gas by means of a pressurized gas supply which comprises a compressor, a main gas storage downstream of the compressor and an intermediate valve downstream of the main gas storage.

According to one aspect of the proposed method, the pressure of an intermediate gas storage located downstream of the intermediate valve and/or downstream of the main gas storage is controlled, in particular by means of a control apparatus, an intermediate pressure sensor and/or the intermediate valve, mostly preferred in order to maintain or adapt the pressure in the intermediate gas storage, mostly preferred dependent on the required load and/or dependent on the apparatus to be activated/deactivated and/or independent of the pressure in the main gas storage and/or independent of the compressor.

Due to the intermediate gas storage, it is not necessary to adapt the pressure of the (larger) main gas storage, when another load is required and/or another apparatus is to be activated/deactivated.

According to a further aspect of the present invention, which can be realized independently, the intermediate valve is embodied as a solenoid valve, in particular a solenoid operated directional control valve, wherein the intermediate valve is (directly) activated/energized, i.e. powered/supplied with electrical energy and/or the power supply of the intermediate valve is turned on, or (directly) deactivated/disconnected/de-energized, i.e. the power supply is cut off, before the intermediate valve or its valve body has reached its end position, i.e. before it has switched completely and/or before the valve body is stopped and/or before the valve body stops to move and/or while still in motion, and/or when the position of the intermediate valve starts to change, in particular when a core/plunger and/or a valve body of the intermediate valve starts to move.

Preferably, the movement of the core/plunger and/or valve body is determined/detected in order to activate or deactivate the intermediate valve (immediately).

Thus, the intermediate valve is preferably only activated for a short time.

In this way, the actuation time, i.e. the time the intermediate valve is activated/energized and/or supplied with electrical energy, and, thus, the time delay of the pressure control is reduced.

Further, the intermediate valve can be operated with a higher switching frequency and pressure changes/fluctuations can be reduced more easily.

Further, the power consumption is reduced and/or the energy efficiency of the analyzer is increased.

Preferably, the electric current (consumption) of the intermediate valve is—directly or indirectly—measured, in particular by means of a control apparatus, for the operation of the intermediate valve and/or in order to determine when the position of the intermediate valve, in particular its valve body, starts to change and/or when its valve body starts to move.

When the position of the intermediate valve starts to change, in particular when its core/plunger and/or valve body starts to move, preferably a (counter) current is produced/induced and/or the power/current consumption and/or current gradient of the intermediate valve is reduced.

Preferably, a change in, e.g. a decrease of, the current gradient of the intermediate valve, in particular a local extremum of the current, is determined/detected, in particular in order to determine when to activate or deactivate the intermediate valve and/or when the position of the intermediate valve, in particular its valve body, starts to change and/or when its valve body starts to move.

This allows an easy implementation of the pressure control method.

Further, a method for inspecting the analyzer is proposed, wherein the pressure drop associated with the operation, in particular the activation, of an apparatus for controlling the fluid flow in a cartridge is measured, in particular in a main gas storage and/or an intermediate gas storage, in order to inspect the analyzer, in particular the apparatus and/or an associated actuation valve.

Preferably the measured pressure drop is compared to the normal/reference pressure drop. In particular, the deviation between the measured pressure drop and the normal/reference pressure drop is used as an indicator, whether the analyzer, in particular the apparatus and/or the associated valve, works properly.

As the apparatus is pneumatically operated, its actuation is associated with air consumption and, thus, a pressure drop within the main gas storage and/or the intermediate gas storage.

Preferably, an air consumption and/or pressure drop that is too high (compared to the normal/reference air consumption and/or pressure drop) is an indicator for a leakage.

Preferably, an air consumption and/or pressure drop that is too low (compared to the normal/reference air consumption and/or pressure drop) is an indicator that the apparatus and/or the associated valve do not work/react correctly.

In this way, an easy and fast inspection of the analyzer is possible, in particular without the need of additional equipment.

In the context of the present invention, the term “analyzer” is preferably understood to refer to a preferably mobile instrument/apparatus, which is designed to chemically, biologically and/or physically tests and/or analyze a sample or a component thereof, preferably in and/or by means of a cartridge containing the sample. The analyzer preferably controls the testing of the sample in and/or by means of the cartridge. In order to carry out the test, the cartridge can be connected to, in particular received by, the analyzer, as already mentioned.

The term “cartridge” is preferably understood to refer to an in particular disposable apparatus or unit which is designed to receive, to store and/or to physically, chemically and/or biologically treat and/or prepare and/or to measure a sample, preferably in order to detect, identify or determine at least one analyte, in particular a protein and/or nucleic-acid sequence, of the sample.

A cartridge within the meaning of the present invention preferably comprises a fluid system having a plurality of channels, cavities and/or valves for controlling the flow through the channels and/or cavities. In particular, a cartridge is at least substantially planar and/or card-like. Mostly preferred, a cartridge is designed as a (micro)fluidic card and/or as a support/container that can be closed and/or inserted and/or plugged in an analyzer when it contains a sample.

The above-mentioned aspects and features of the present invention and the aspects and features of the present invention that will become apparent from the claims and the following description can, in principle, be implemented independently from one another, but also in any combination or order.

Further aspects, features and advantages of the present invention will be apparent from the following description of preferred embodiments with reference to the accompanying drawings.

### BRIEF DESCRIPTION OF THE DRAWINGS

FIG. 1 is a schematic view of a proposed analyzer and a cartridge received therein;

FIG. 2 is a schematic perspective front view of the cartridge;

FIG. 3 is a schematic perspective rear view of the cartridge;

FIG. 4 is a schematic perspective view of the analyzer in the open state;

FIG. 5 is an exploded view of the analyzer;

FIG. 6 is a schematic perspective view of a clamping system of the analyzer;

FIG. 7 is a schematic sectional view of the analyzer, showing the analyzer in the open position;

FIG. 8 is a schematic sectional view of the analyzer according to FIG. 7, showing the analyzer in a test position;

FIG. 9 is a schematic perspective view of a connection unit of the analyzer;

FIG. 10 is a schematic diagram of a pressurized gas supply of the analyzer; and

FIG. 11 is a schematic diagram of the current as a function of time when a valve of the pressurized gas supply is activated.

### DETAILED DESCRIPTION OF THE INVENTION

In the drawings, the same reference signs are used for the same or similar parts and components, resulting in corresponding or comparable properties, features and advantages, even if these are not repeatedly described.

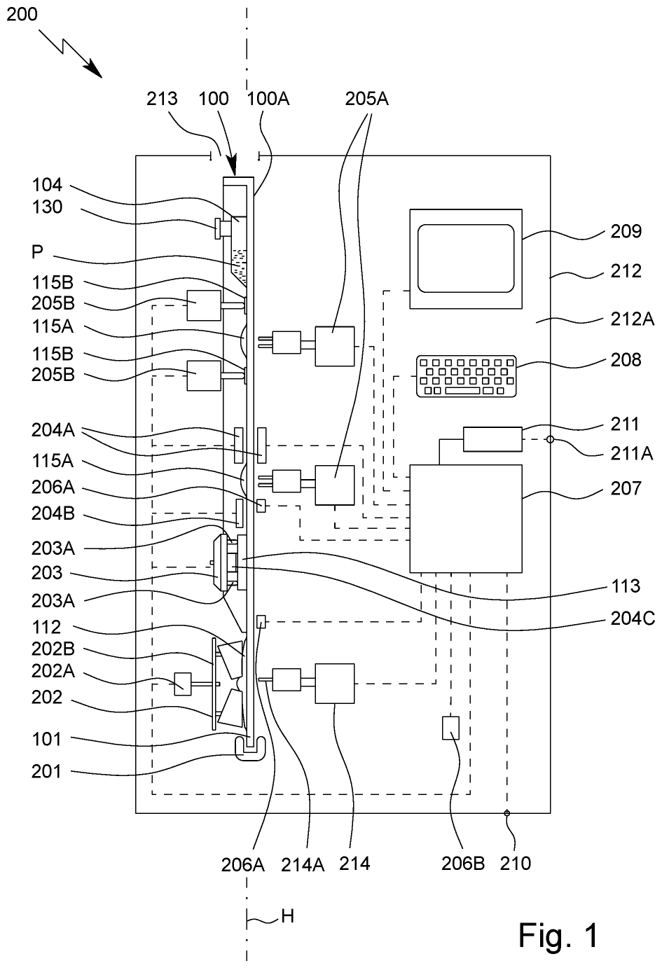

FIG. 1 is a highly schematic view of a proposed analyzer 200 comprising an apparatus or cartridge 100 for testing an in particular biological sample P.

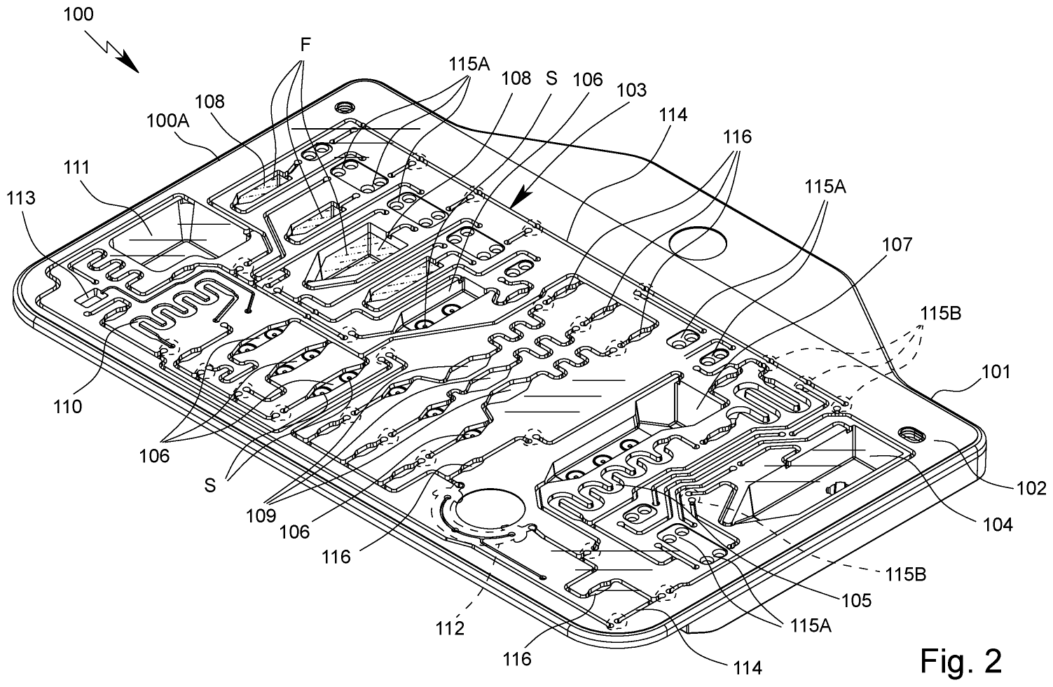

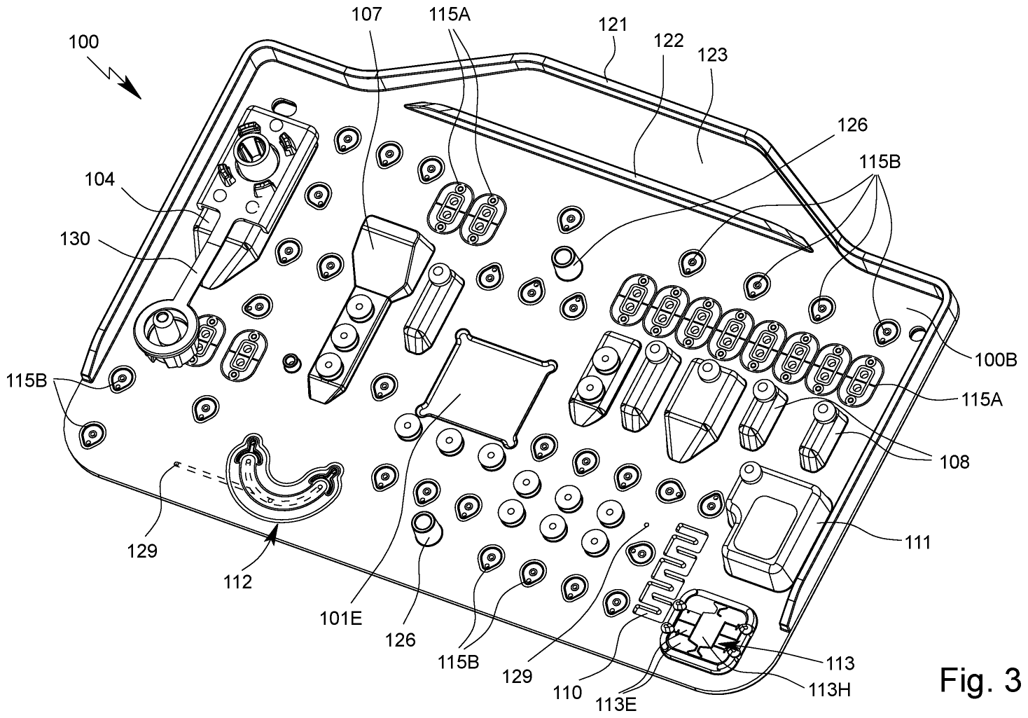

FIG. 2 is a perspective front view of the cartridge 100 showing its front 100A and FIG. 3 is a perspective rear view thereof, showing its back 100B.

The apparatus or cartridge 100 in particular forms a handheld unit, hereinafter referred to as cartridge 100.

The term “sample” is preferably understood to refer to a sample material that is to be tested and which is in particular taken from a human or animal. Preferably, within the meaning of the present invention, a sample is a fluid, such as saliva, blood, urine or another liquid, preferably from a human or animal, or a component thereof.

Within the meaning of the present invention, a sample may be pre-treated or prepared if necessary, or may come directly from a human or animal or the like. A food sample, environmental sample or another sample may optionally also be tested, in particular for environmental analytics, food safety and/or for detecting other substances, preferably natural substances, but also biological or chemical warfare agents, poisons or the like.

A sample within the meaning of the present invention preferably contains one or more analytes, it preferably being possible for the analytes to be identified or detected, in particular qualitatively and/or quantitatively determined. Preferably, within the meaning of the present invention, a sample has target nucleic-acid sequences as analytes, in particular target DNA sequences and/or target RNA sequences, and/or target proteins as the analytes, in particular target antigens and/or target antibodies. Preferably, at least one disease and/or pathogen can be detected or identified in the sample P by qualitatively and/or quantitatively determining the analytes.

Preferably, the analyzer 200 controls the testing of the sample P, in particular in or on the cartridge 100, and/or is used to evaluate the testing and/or to collect, to process and/or to store measured values from the test.

By means of the analyzer 200 and/or by means of the cartridge 100 and/or by means of the method for testing the sample P, an analyte or a plurality of analytes of the sample P can preferably be determined, identified or detected, in particular not only qualitatively, but also quantitatively.

Therefore, the sample P can in particular be tested for qualitatively and/or quantitatively determining at least one analyte, e.g. in order to detect or identify a disease and/or a pathogen or to determine other values, which are important for diagnostics, for example.

The cartridge 100 is preferably at least substantially planar, flat, plate-shaped and/or card-like.

The cartridge 100 preferably comprises an in particular at least substantially planar, flat, plate-shaped and/or card-like main body/support 101, the main body or support 101 in particular being made of and/or injection-moulded from plastic material, in particular polypropylene.

The cartridge 100 preferably comprises two flat sides 100A, 100B. In particular, the front 100A of the cartridge 100 and the back 100B of the cartridge 100 are each a flat side of the in particular planar and/or card-like cartridge 100.

The cartridge 100 preferably comprises at least one film/cover 102 for covering the main body 101 and/or cavities and/or channels formed therein, at least partially, in particular on the front 100A, and/or for forming valves or the like.

The cartridge 100 and/or its main body 101, in particular together with the cover 102, preferably forms and/or comprises a fluidic system 103, hereinafter referred to as fluid system 103.

The cartridge 100, the main body 101 and/or the fluid system 103 are/is preferably at least substantially vertically oriented during the operation/test and/or in the test/operating position and/or when being inserted in the analyzer 200, as shown schematically in FIG. 1. In particular, the surface extension or main plane H of the cartridge 100 extends at least substantially vertically in the test/operating position.

The cartridge 100, in particular its fluid system 103, preferably comprises a plurality of cavities, in particular at least one receiving cavity 104 for receiving/introducing the sample P, at least one metering cavity 105, at least one intermediate cavity 106, at least one mixing cavity 107, at least one storage cavity 108, at least one reaction cavity 109, at least one intermediate temperature-control cavity 110 and/or at least one collection cavity 111, a plurality of cavities preferably being fluidically interconnected in particular by a plurality of channels.

Within the meaning of the present invention, channels are preferably elongate forms for conducting a fluid in a main flow direction, the forms preferably being closed transversely, in particular perpendicularly, to the main flow direction and/or longitudinal extension, preferably on all sides.

In particular, the main body 101 comprises elongate notches, recesses, depressions or the like, which are closed at the side by the cover 102 and form channels within the meaning of the present invention.

Within the meaning of the present invention, cavities or chambers are preferably formed by recesses, depressions or the like in the cartridge 100 or main body 101, which are closed or covered by the cover 102, in particular at the side. The volume or space enclosed by each cavity is preferably fluidically linked, in particular to the fluid system 103, by means of channels.

In particular, within the meaning of the present invention, a cavity comprises at least two openings for the inflow and/or outflow of fluids.

Within the meaning of the present invention, cavities preferably have a larger diameter and/or flow cross section than channels, preferably by at least a factor of 2, 3 or 4. In principle, however, cavities may in some cases also be elongate, in a similar manner to channels.

The cartridge 100 and/or the fluid system 103 preferably comprises at least one pump apparatus 112 and/or at least one sensor arrangement/apparatus 113.

In the example shown, the cartridge 100 or the fluid system 103 preferably comprises a plurality of intermediate cavities 106, a plurality of storage cavities 108 and/or a plurality of reaction cavities 109, which can preferably be loaded separately from one another.

In the initial state of the cartridge 100 or when at the factory, the storage cavities 108 are preferably filled at least in part, in particular with a liquid such as a reagent, solvent or wash buffer.

The reaction cavity/cavities 109 is/are preferably designed to allow a substance located in the reaction cavity 109 to react when an assay is being carried out.

The reaction cavity/cavities 109 is/are used in particular to carry out an amplification reaction, in particular PCR, or several, preferably different, amplification reactions, in particular PCRs. It is preferable to carry out several, preferably different, PCRs, i.e. PCRs having different primer combinations or primer pairs, in parallel and/or independently and/or in different reaction cavities 109.

“PCR” stands for polymerase chain reaction and is a molecular-biological method by means of which certain analytes, in particular portions of RNA or RNA sequences or DNA or DNA sequences, of a sample P are amplified, preferably in several cycles, using polymerases or enzymes, in particular in order to subsequently test and/or detect the amplification products or nucleic-acid products. If RNA is intended to be tested and/or amplified, before the PCR is carried out, a cDNA is produced starting from the RNA, in particular using reverse transcriptase. The cDNA is used as a template for the subsequent PCR.

The amplification products, target nucleic-acid sequences and/or other portions of the sample P produced in one or more reaction cavities 109 can be conducted or fed to the connected sensor arrangement or sensor apparatus 113, in particular by means of the pump apparatus 112.

The sensor arrangement or sensor apparatus 113 is used in particular for detecting, particularly preferably qualitatively and/or quantitatively determining, the analyte or analytes of the sample P, mostly preferred the target nucleic-acid sequences and/or target proteins as the analytes. Alternatively or additionally, however, other values may also be collected and/or determined.

The sensor apparatus 113 preferably comprises a sensor array (not shown) in order to determine or detect in particular a plurality of analytes.

In particular, the sensor apparatus 113 or sensor array comprises capture molecules (not shown) in order to bond analytes and/or amplification products and subsequently detect, identify or determine said analytes and/or amplification products in a detection process.

Mostly preferred, electrochemical detection is carried out.

The cartridge 100, the main body 101 and/or the fluid system 103 preferably comprise a plurality of channels 114 and/or valves 115, as shown in FIG. 2.

By means of the channels 114 and/or valves 115, the cavities 104 to 111, the pump apparatus 112 and/or the sensor apparatus 113 can be temporarily and/or permanently fluidically interconnected and/or fluidically separated from one another, as required and/or optionally or selectively, in particular such that they are controlled by the analyzer 200.

The cavities 104 to 111 are preferably each fluidically linked or interconnected by a plurality of channels 114. In particular, each cavity is linked or connected by at least two associated channels 114, such that the fluid can fill, flow through and/or drain from the respective cavities as required.

The fluid transport or the fluid system 103 is preferably not or not exclusively based on capillary forces, but is preferably essentially based on the effects of gravity and/or pumping forces, compressive forces and/or suction forces that arise and/or that are generated by the pump or pump apparatus 112.

Mostly preferred, the flow or transport of fluids and the metering are controlled by accordingly opening and closing the valves 115 and/or by accordingly operating the pump apparatus 112, in particular by means of the analyser 200, in particular its pump drive 202.

Preferably, at least one valve 115 is assigned to each cavity, the pump apparatus 112 and/or the sensor apparatus 113 and/or is arranged upstream of the respective inlets and/or downstream of the respective outlets.

Preferably, by actuation of the assigned valves 115, the cavities 104 to 111 or sequences of cavities 104 to 111, can be selectively released and/or fluid can selectively flow therethrough, and/or the cavities 104 to 111 can be fluidically connected to the fluid system 103 and/or to other cavities.

In particular, the valves 115 are formed by the main body 101 and the film/cover 102 and/or are formed therewith and/or are formed in another manner, e.g. by additional layers, depressions or the like.

Preferably, one or more valves 115A are—preferably tightly—closed initially and/or in the delivery state of the cartridge 100, in particular in order to seal liquids or liquid reagents F, located in the storage cavities 108, and/or the fluid system 103 from the open receiving cavity 104 and/or in a storage-stable manner Hereinafter, these valves 115A are referred to as initially closed valves 115A.

Preferably, an initially closed valve 115A is arranged upstream and downstream of each storage cavity 108. Said valves 115A are preferably (only) opened, in particular automatically and/or by means of the analyzer 200, when the cartridge 100 is actually being used, in particular for the first time, and/or during or after inserting the cartridge 100 into the analyzer 200 and/or for carrying out the assay.

The initially closed valves 115A assigned to the receiving cavity 104 seal the fluid system 103 and/or the cartridge 100 in particular fluidically and/or in a gas-tight manner, preferably until the sample P is introduced and/or the receiving cavity 104 is closed.

As an alternative or in addition to the initially closed valves 115A, one or more valves 115B are preferably provided which are open/not closed initially/normally and/or in the delivery state of the cartridge 100 and/or in an inoperative/initial position/state and/or when the cartridge 100 is not inserted into the analyzer 200. These valves 115B are used in particular to control the flows of fluid during the test and/or are referred to as initially/normally open valves 115B.

Preferably, the normally open valves 115B can (only) be closed by actuation, mostly preferred by means of the analyzer 200.

The cartridge 100 is preferably designed as a microfluidic card and/or the fluid system 103 is preferably designed as a microfluidic system.

In the present invention, the term “microfluidic” is preferably understood to mean that the respective volumes of the individual cavities, some of the cavities or all of the cavities 104 to 111 and/or channels 114 are, separately or cumulatively, less than 5 ml or 2 ml, preferably less than 1 ml or 800 μl, in particular less than 600 μl or 300 μl, mostly preferred less than 200 μl or 100 μl.

Preferably, a sample P having a maximum volume of 5 ml, 2 ml or 1 ml can be introduced into the cartridge 100 and/or the fluid system 103, in particular the receiving cavity 104.

For example, the sample P may be introduced into the receiving cavity 104 and/or cartridge 100 by means of a pipette, syringe or other instrument.

Preferably, (all) reagents and liquids required for the test, the detection process and/or for other purposes are provided in the cartridge 100, i.e. introduced before the test, mostly preferred in liquid form as liquids or liquid reagents F and/or in dry form as dry reagents S, as indicated in the schematic view according to FIG. 2.

Furthermore, also (all) other liquids F required for the test, the detection process and/or for other purposes, in particular in the form of a wash buffer, a solvent for dry reagents S and/or a substrate, e.g. in order to form detection molecules and/or a redox system, are preferably provided in the cartridge 100, i.e. introduced before use, in particular before delivery.

The cartridge 100 preferably contains all the reagents and liquids required for pre-treating the sample P and/or for carrying out the test or assay, in particular for carrying out one or more amplification reactions or PCRs. Therefore, it is preferably only necessary to receive the optionally pre-treated sample P.

The cartridge 100, the fluid system 103 and/or the channels 114 preferably comprise sensor portions 116 or other apparatuses for detecting liquid fronts and/or flows of fluid.

It is noted that in FIGS. 2 and 3 various components, such as the channels 114, the valves 115, in particular the initially closed valves 115A and the normally open valves 115B, and the sensor portions 116 are, for reasons of clarity, only labelled in some cases. However, the same symbols are used in FIGS. 2 and 3, respectively, for each of these components.

As shown in FIG. 3, the sensor apparatus 113 preferably comprises electrical contacts 113E for electrically connecting the cartridge 100 and/or sensor apparatus 113.

The contacts 113E are arranged in particular on the flat side and/or back and/or around a central region 113H.

The cartridge 100 and/or the main body 101 preferably comprises a reinforced or angled edge 121 and/or a reinforcing rib 122, particularly preferably on the back 100B, as shown schematically in FIG. 3.

The cartridge 100 or the main body 101 preferably comprises a grip portion 123 in order to optimally grip and/or hold the cartridge 100 by hand. The grip portion 123 is in particular arranged and/or formed or integrally moulded on a longitudinal side.

The edge 121 and/or the reinforcing rib 122 are used in particular to provide reinforcement for the cartridge 100 or the main body 101 transversely to the surface extension or plate plane H or flat side or back 100B. This is particularly advantageous when mounting/clamping the cartridge 100 in the analyzer 200. The increased rigidity makes it possible to apply high forces when mounting/clamping the cartridge 100.

The cartridge 100 and/or the main body 101 preferably has, in the region of the reaction cavity/cavities 109, a region of reduced wall thickness, a weakened portion or a depression 101E in order to allow or ensure that the reaction cavity/cavities 109 and/or the fluids located therein is/are thermally coupled to the associated reaction temperature-control apparatus 204A in an effective or improved manner.

The cartridge 100 or the main body 101 preferably comprises at least one positioning portion 126, in particular two positioning portions 126 in the example shown, for mounting and/or positioning the cartridge 100 in a defined manner, in particular in the analyzer 200 while a sample P is being tested, as shown in FIG. 3.

The positioning portion 126 is in particular integrally moulded on or formed in one piece with the main body 101.

The positioning portion 126 preferably projects from a flat side, in this case the back 100B, or the main plane H of the cartridge 100 or main body 101.

The positioning portion 126 is in particular cylindrical or hollow cylindrical and/or conical, preferably on the inside and/or outside.

The outside of the positioning portion 126 preferably tapers towards the free end or is conical. This is conducive to simple production and/or centering of the cartridge 100 in the analyzer 200.

The inside of the positioning portion 126 is preferably conical or widens towards the free end. This is conducive to simple production and/or centering of the cartridge 100 in the analyzer 200.

The two positioning portions 126 are preferably arranged in a line that is parallel to a side of the cartridge 100, in particular in a central line that is transverse to a longitudinal side of the cartridge 100.

In particular, in the view according to FIG. 3, one positioning portion 126 is arranged in the region of the lower longitudinal side of the cartridge 100. The other positioning portion 126 is arranged in particular in the vicinity of the optional reinforcing rib 122.

The cartridge 100 or the main body 101 preferably comprises a fluidic and/or pneumatic connection 129. In the example shown, preferably a plurality of connections or two connections 129 are provided.

The connection 129 or each connection 129 is used in particular for fluidically or pneumatically supplying an associated manipulating apparatus or for actuating said manipulating apparatus.

In the example shown, the connection 129 on the left-hand side is assigned in particular to the pump apparatus 112 and is preferably used to pneumatically reset a peristaltic pump formed by the pump apparatus 112.

In the example shown, the connection 129 on the right-hand side is preferably assigned to the sensor apparatus 113 and is used in particular to pneumatically actuate a sensor cover (not shown) in order to make a sensor compartment above the sensor apparatus 113 or sensor array smaller, in particular during detection.

Each connection 129 is preferably formed by a corresponding opening in the main body 101, in particular its back 100B.

A card-side seal, formed in particular by a suitable layer or film or the like, is preferably assigned to each connection 129. However, other technical solutions are also possible.

The receiving cavity 104 can be closed after the sample P has been received. The cartridge 100 preferably comprises a closure element 130 for this purpose.

In particular, the receiving cavity 104 can be closed in a liquid-tight and particularly preferably also gas-tight manner by the closure element 130. In particular, a closed fluid circuit can thus be formed, with the receiving cavity 104 being included. In particular, once the assigned valves 115A at the inlet, outlet and/or an intermediate connection of the receiving cavity 104 have been opened, the receiving cavity 104 thus forms part of the fluid system 103 of the cartridge 100, wherein the fluid system is preferably closed or can be closed by the closure element 130.

Once the sample P has been introduced into the receiving cavity 104 and said cavity has been closed, in particular by means of the closure element 130, the cartridge 100 can be inserted into and/or received in the proposed analyzer 200 in order to test the sample P, as shown in FIG. 1.

The analyzer 200 preferably comprises a preferably movable mount or receptacle 201 for mounting and/or receiving the cartridge 100. Preferably, the receptacle 201 can be moved up and down in order to eject and receive the cartridge 100, respectively.

Preferably, the cartridge 100 and/or the fluid system 103 is fluidically, in particular hydraulically, separated or isolated from the analyzer 200. In particular, the cartridge 100 forms a preferably independent and in particular closed or sealed fluidic or hydraulic system 103 for the sample P and the reagents and other liquids. In this way, the analyzer 200 does not come into direct contact with the sample P and/or other fluids and/or reagents and can in particular be reused for another test without being disinfected and/or cleaned first.

It is however provided that the analyzer 200 is connected or coupled mechanically, electrically, thermally and/or fluidically and/or pneumatically to the cartridge 100.

In particular, the analyzer 200 is designed to have a mechanical effect, in particular for actuating the pump apparatus 112 and/or the valves 115, and/or to have a thermal effect, in particular for temperature-controlling the reaction cavity/cavities 109 and/or the intermediate temperature-control cavity 110 and/or the sensor apparatus 113.

In addition, the analyzer 200 can preferably be pneumatically connected to the cartridge 100, in particular in order to actuate individual apparatuses, and/or can be electrically connected to the cartridge 100, in particular in order to collect and/or transmit measured values, for example from the sensor apparatus 113 and/or sensor portions 116.

The analyzer 200 preferably comprises a pump drive 202, the pump drive 202 in particular being designed for mechanically actuating the pump apparatus 112.

The analyzer 200 preferably comprises a connection apparatus 203 for in particular electrically and/or thermally connecting the cartridge 100 and/or the sensor arrangement or sensor apparatus 113.

As shown in FIG. 1, the connection apparatus 203 preferably comprises a plurality of electrical contact elements 203A, the cartridge 100, in particular the sensor arrangement or sensor apparatus 113, preferably being electrically connected or connectable to the analyzer 200 by the contact elements 203A.

The analyzer 200 preferably comprises one or more temperature-control apparatuses 204 for temperature-controlling the cartridge 100 and/or having a thermal effect on the cartridge 100, in particular for heating and/or cooling, the temperature-control apparatus(es) 204 (each) preferably comprising or being formed by a heating resistor or a Peltier element.

Preferably, individual temperature-control apparatuses 204, some of these apparatuses or all of these apparatuses can be positioned against the cartridge 100, the main body 101, the cover 102, the sensor apparatus 113 and/or individual cavities and/or can be thermally coupled thereto and/or can be integrated therein and/or can be operated or controlled in particular electrically by the analyzer 200. In the example shown, three different temperature-control apparatuses 204A, 204B and/or 204C are provided.

The analyzer 200 preferably comprises one or more actuator apparatuses 205 for actuating the valves 115. Preferably, different (types or groups of) actuator apparatuses 205A and 205B are provided which are assigned to the different (types or groups of) valves 115A and 115B for actuating each of said valves, respectively. Mostly preferred, the analyzer 200 comprises one or more actuator apparatuses 205A for actuating the initially closed valves 115A and one or more actuator apparatuses 205B for the normally open valves 115B.

The analyzer 200 preferably comprises one or more sensors 206. In particular, fluid sensors 206A are assigned to the sensor portions 116 and/or are designed or intended to detect liquid fronts and/or flows of fluid in the fluid system 103.

Mostly preferred, the fluid sensors 206A are designed to measure or detect, in particular in a contact-free manner, for example optically and/or capacitively, a liquid front, flow of fluid and/or the presence, the speed, the mass flow rate/volume flow rate, the temperature and/or another value of a fluid in a channel and/or a cavity, in particular in a respectively assigned sensor portion 116, which is in particular formed by a planar and/or widened channel portion of the fluid system 103.

Alternatively or additionally, the analyzer 200 preferably comprises one or more (other or additional) sensors 206B for detecting the ambient temperature, internal temperature, atmospheric humidity, position and/or alignment, for example by means of a GPS sensor, and/or the orientation and/or inclination of the analyzer 200 and/or the cartridge 100.

The analyzer 200 preferably comprises a control apparatus 207, in particular comprising an internal clock or time base for controlling the sequence of a test or assay and/or for collecting, evaluating and/or outputting or providing measured values in particular from the sensor apparatus 113, and/or from test results and/or other data or values.

The control apparatus 207 preferably controls or feedback controls the pump drive 202, the temperature-control apparatuses 204 and/or actuator apparatuses 205, in particular taking into account or depending on the desired test and/or measured values from the sensor apparatus 113 and/or sensors 206.

Optionally, the analyzer 200 comprises an input apparatus 208, such as a keyboard, a touch screen or the like, and/or a display apparatus 209, such as a screen.

The analyzer 200 preferably comprises at least one interface 210, for example for controlling, for communicating and/or for outputting measured data or test results and/or for linking to other devices, such as a printer, an external power supply or the like. The interface 210 might be embodied as a wired or wireless interface 210.

The analyzer 200 preferably comprises a power supply 211 for providing electrical power, preferably a battery or an accumulator, which is in particular integrated and/or externally connected or connectable.

Preferably, an integrated accumulator is provided as a power supply 211 and is (re)charged by an external charging device (not shown) via a connection 211A and/or is interchangeable.

The analyzer 200 is preferably portable or mobile. Preferably, the analyzer 200 weighs less than 25 kg or 20 kg, mostly preferred less than 15 kg or 10 kg, in particular less than 9 kg or 6 kg.

The analyzer 200 preferably comprises a housing 212, preferably wherein all the components and/or some or all of the apparatuses of the analyzer 200 are integrated in the housing 212 and/or arranged in the interior space 212A thereof.

Mostly preferred, the cartridge 100 can be inserted or slid into the housing 212, and/or can be received by the analyzer 200, through an opening 213 which can in particular be closed, such as a slot or the like.

As already explained, the analyzer 200 can preferably be fluidically and/or pneumatically linked or connected to the cartridge 100, in particular to the sensor apparatus 113 and/or to the pump apparatus 112, preferably by means of one or more—fluidic or pneumatic—connections 129.

Mostly preferred, the analyzer 200 is designed to supply the cartridge 100, in particular the sensor apparatus 113 and/or the pump apparatus 112, with a working medium, preferably gas, in particular air.

Preferably, the working medium can be compressed and/or pressurized in the analyzer 200 or by means of the analyzer 200.

The analyzer 200 preferably comprises a pressurized gas supply 214 in order to provide a pressurized/compressed working medium, preferably gas, in particular air.

The pressurized gas supply 214 is preferably integrated in the analyzer 200 or the housing 212 and/or can be controlled or feedback controlled by means of the control apparatus 207.

Preferably, the pressurized gas supply 214 is electrically operated or can be operated by electrical power. In particular, the pressurized gas supply 214 can be supplied with electrical power by means of the power supply 211.

The analyzer 200 and/or pressurized gas supply 214 preferably comprises a connection element 214A, in particular in order to pneumatically connect the analyzer 200 and/or pressurized gas supply 214 to the cartridge 100, in particular the sensor apparatus 113 and/or pump apparatus 112, mostly preferred via the connection 129 or connections 129.

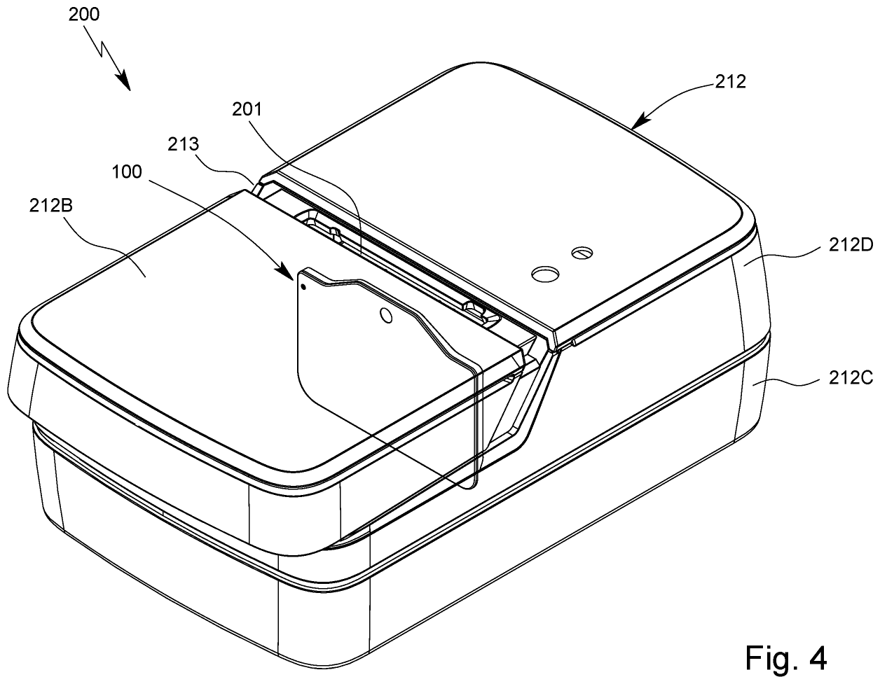

FIG. 4 shows the analyzer 200 in the open state/position, i.e. when the receptacle 201 is accessible and/or the opening 213 is formed. Here, the cartridge 100 has already been inserted into the analyzer 200, preferably through the opening 213 into the receptacle 201.

The analyzer 200 or housing 212 preferably comprises an access cover/housing part 212B that can be opened. Preferably, the analyzer 200, in particular its housing 212, can be opened by moving the access cover/housing part 212B relative to the housing 212, in particular a base 212C thereof, and/or such that the opening 213 is formed and/or the receptacle 201 is accessible, mostly preferred from the top.

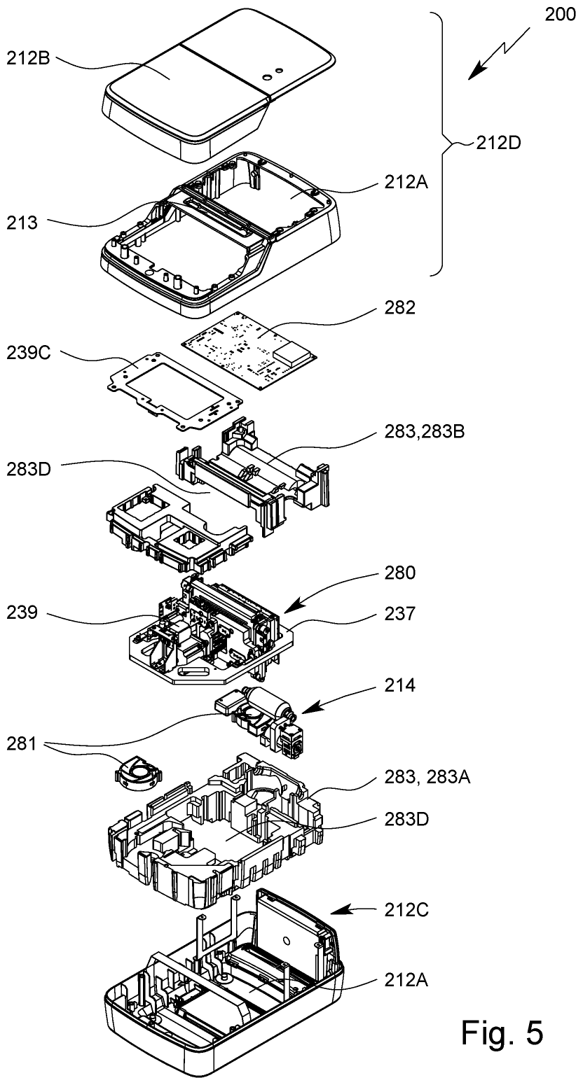

FIG. 5 is an exploded view of the analyzer 200, showing its preferred assembly.

As already mentioned the analyzer preferably comprises a housing 212 that contains/encompasses the main, in particular all, (mechanical or electrical) parts/components of the analyzer 200.

The analyzer 200 preferably comprises a preferably mechanical closing/clamping system 280, pressurized gas supply 214, at least one ventilation apparatus 281, at least one electronic unit 282 and/or a support/cushion 283.

The clamping system 280 is preferably adapted to receive, hold, mount, position/align or clamp the cartridge 100 within the analyzer 200, in particular the housing 212, mostly preferred in order to conduct the test with the cartridge 100 in a pre-defined position.

The ventilation apparatus 281 is preferably adapted to ventilate/cool the analyzer 200 or a housing 212, in particular its interior 212A. In the embodiment shown in FIG. 5, the analyzer 200 preferably comprises several, here two, ventilation apparatuses 281.

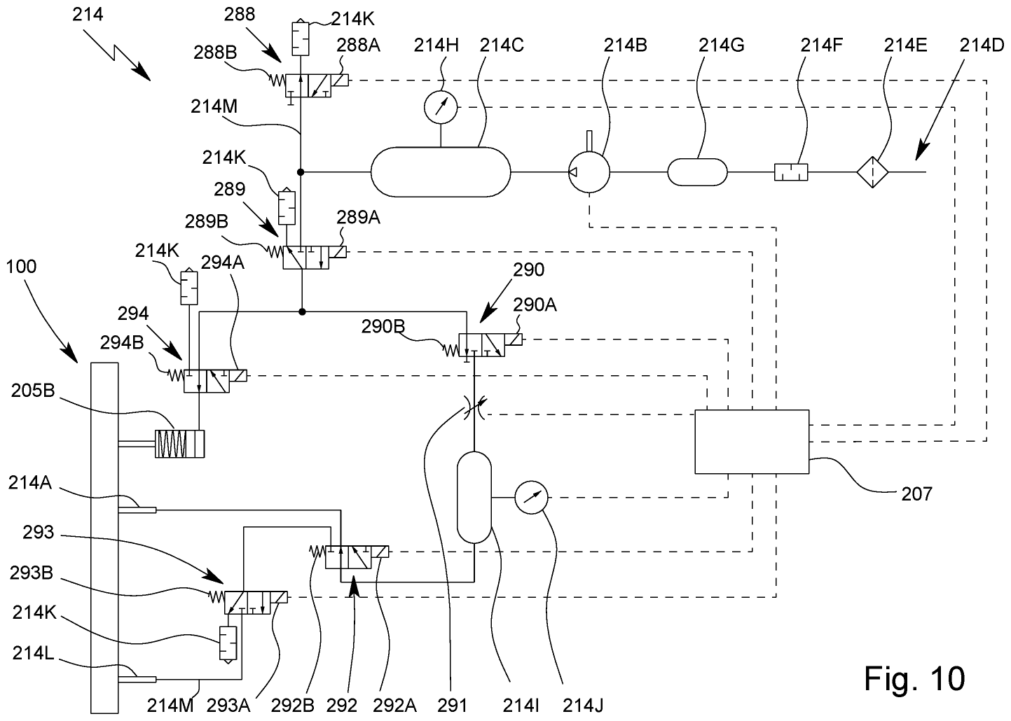

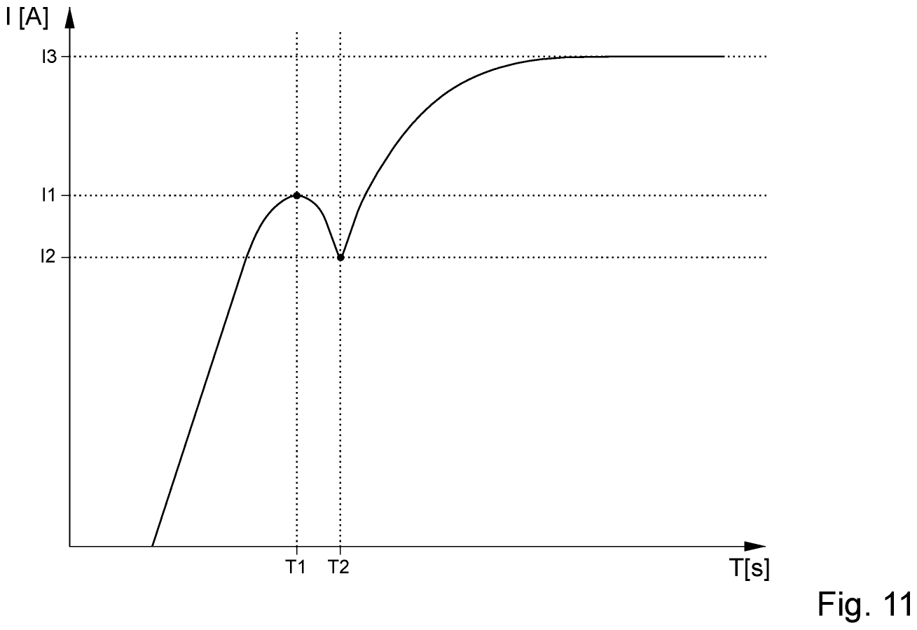

As already mentioned, the pressurized gas supply 214 is preferably adapted to provide pressurized gas, preferably to the cartridge 100, in particular its sensor apparatus 113 and/or pump apparatus 112. The pressurized gas supply 214 will be described later in detail with reference to FIGS. 10 and 11.

In the present embodiment, the pressurized gas supply 214, the clamping system 280, the ventilation apparatus 281 and the electronic unit 282 are preferably not rigidly connected to one another and, thus, do not form an assembly group/unit. However, it is also possible that some or all of these parts/components are rigidly connected to one another and/or form a (common) assembly group/unit. In particular, the pressurized gas supply 214, the ventilation apparatus 281 and/or the electronic unit 282 might be integrated into the clamping system 280.

The housing 212 is preferably a multi-piece construction and/or comprises a base 212C and a top 212D.

The support/cushion 283, herein after referred to as cushion 283, is preferably arranged within the housing 212.

The cushion 283 is preferably adapted to hold, support, bear, align and/or position some or all parts of the analyzer 200, in particular the pressurized gas supply 214, the clamping system 280, the ventilation apparatus 281 and/or the electronic unit 282, within the housing 212, in particular its interior 212A, mostly preferred such that these parts are immovable relative to one another, the cushion 283 and/or the housing 212.

In particular, the cushion 283 is adapted to secure these parts against unwanted/accidental displacement.

The cushion 283 preferably of multi-piece construction and/or comprises a base 283A and a top 283B.

Preferably, the cushion 283 is connected to the housing 212 in a force-fitting and/or form-fitting manner and/or by welding.

Mostly preferred, the outer shape/contour of the cushion 283 corresponds at least essentially to the inner shape/contour of the housing 212, in particular the interior 212A, in particular such that the cushion 283 sits firmly, immovably and/or in a form-fit manner within the housing 212.

The cushion 283 preferably comprises or forms an interior 283D that corresponds to and/or matches the parts that are supported by the cushion 283, in particular the pressurized gas supply 214, the clamping system 280, the ventilation apparatus 281 and/or the electronic unit 282.

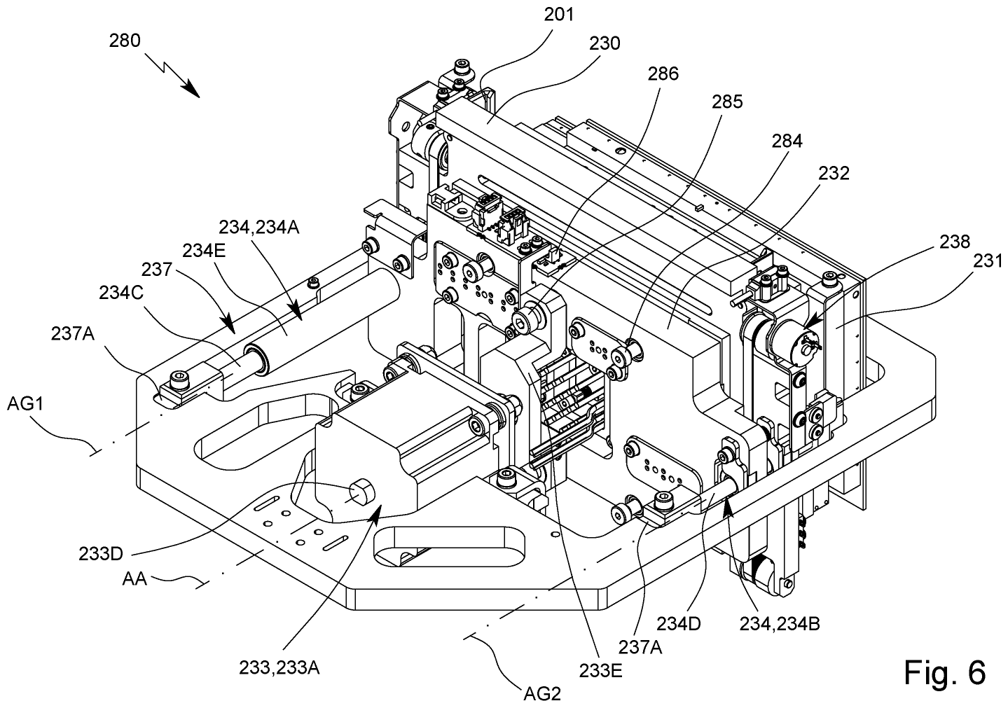

In the following, the clamping system 280 will be described in detail with reference to FIGS. 6 to 8.

FIG. 6 shows a schematic perspective view of the clamping system 280.

The analyzer 200, in particular the clamping system 280, is preferably designed to receive, position/align, hold and/or clamp the cartridge 100, in particular such that the cartridge 100 is positioned/aligned and/or firmly held within the analyzer 200, in particular the clamping system 280, mostly preferred in a pre-defined and/or repeatable manner, and/or can be mechanically, electrically, thermally, fluidically and/or pneumatically connected, mostly preferred to the pump drive 202, the connection apparatus 203, the temperature-control apparatus 204, the reaction temperature-control apparatus 204A, the intermediate temperature-control apparatus 204B, the sensor temperature-control apparatus 204C, the actuator(s) 205, the sensor(s) 206, the control apparatus 207, the input apparatus 208, the display apparatus 209, the interface 210, the power supply 211 and/or the pressurized gas supply 214.

The analyzer 200, in particular the clamping system 280, preferably comprises an optional receiving/intermediate unit 230, a connection unit 231, a clamping/actuator unit 232, a drive apparatus 233, a guide apparatus 234, a rack/frame 237, a lifting apparatus 238 and/or an opening apparatus 239.

The clamping system 280, in particular the clamping unit 232, the intermediate unit 230, the connection unit 231 and/or the lifting apparatus 238, preferably comprise(s) or form(s) the slot/receptacle 201 for mounting and/or receiving the cartridge 100.

Mostly preferred, the receptacle 201 is formed/arranged between the clamping unit 232 and/or the intermediate unit 230 on the one hand and the connection unit 231 on the other hand.

In particular, the receptacle 201 is laterally limited by the intermediate unit 230, connection unit 231 and/or clamping unit 232 and/or at the bottom by means of the lifting apparatus 238.

Preferably, the optional intermediate unit 230 and/or the lifting apparatus 238 are arranged between the clamping unit 232 and the connection unit 231.

The intermediate unit 230, the connection unit 231, the clamping unit 232 and/or the lifting apparatus 238 are preferably movable/slidable relative to one another and/or back and forth, in particular in order to hold the cartridge 100 in a clamped manner for the test and/or in a test position and/or to release/eject the cartridge 100 after the test has been completed.

Due to the movement of the intermediate unit 230, connection unit 231 and/or clamping unit 232 relative to one another, the distance between the intermediate unit 230, connection unit 231 and/or clamping unit 232 and, thus, the volume of the receptacle 201 can be reduced and increased.

The intermediate unit 230, connection unit 231 or its main body 231D and/or clamping unit 232 are preferably at least essentially flat and/or plate-like and/or constructed/assembled from a plurality of plates or plate-shaped components.

The intermediate unit 230, connection unit 231 and/or clamping unit 232 and/or the respective main planes thereof are preferably arranged at least essentially parallel to one another and/or side by side.

The drive apparatus 233 is preferably adapted to move/actuate the clamping unit 232, intermediate unit 230, connection unit 231 and/or the lifting apparatus 238.

Mostly preferred, the drive apparatus 233 is adapted to push the clamping unit 232, intermediate unit 230, connection unit 231 and/or the lifting apparatus 238 in order to clamp/position/align the cartridge 100, in particular between the clamping unit 232 and the connection unit 231, and/or to pull the clamping unit 232, intermediate unit 230, connection unit 231 and/or the lifting apparatus 238 in order to release the cartridge 100 for ejection and/or when the test has been completed.

Thus, the drive apparatus 233 preferably operates into two (opposing) directions, in particular a first actuation direction towards the connection unit 231 and a second actuation direction away from the connection unit 231.

The drive apparatus 233 preferably comprises an in particular electrical drive/motor 233A, a shaft 233D and/or a preferably fork-shaped drive head 233E.

Preferably, the drive apparatus 233, in particular its drive 233A, is embodied as a stepper motor and/or comprises a threaded spindle as shaft 233D. However, other constructional solutions are possible as well.

In the present embodiment, the connection unit 231 is preferably fixed, immovable and/or stationary, in particular relative to the drive apparatus 233 and/or rack 237, and/or only the clamping unit 232, the intermediate unit 230 and/or the lifting apparatus 238 are movable/slidable and/or driven by means of the drive apparatus 233. However, other constructional solutions are possible as well, wherein the connection unit 231 is movable/slidable, in particular additionally or alternatively to the intermediate unit 230, the clamping unit 232 and/or the lifting apparatus 238. The connection unit 231 might be driven by the drive apparatus 233 or an additional drive apparatus.

The following description mainly refers to the present embodiment, i.e. with regard to the movement of the clamping unit 232, the intermediate unit 230 and/or the lifting apparatus 238, but may also apply to other embodiments correspondingly, in particular in which the connection unit 231 is movable/slidable additionally or alternatively to the clamping unit 232, the intermediate unit 230 and/or the lifting apparatus 238.

The drive apparatus 233 is preferably adapted to move/actuate the clamping unit 232, the intermediate unit 230 and/or the lifting apparatus 238 back and forth and/or in the direction of and away from the (preferably fixed) connection unit 231.

The drive apparatus 233, in particular its shaft 233D, preferably comprises/defines an actuation axis AA, preferably wherein the shaft 233D and/or the actuation axis AA are/is arranged at least essentially perpendicular to the intermediate unit 230 or its main plane, the connection unit 231 or its main plane and/or the clamping unit 232 or its main plane and/or runs at least essentially centrally through the intermediate unit 230, connection unit 231 and/or clamping unit 232 and/or through the center of gravity of the analyzer 200, in particular of the clamping system 280, of the intermediate unit 230, of the connection unit 231 and/or of the clamping unit 232.

The drive apparatus 233, in particular its drive head 233E, is preferably attached to (the center of) the clamping unit 232 and/or (the center of) the intermediate unit 230.

Preferably, the clamping unit 232 and/or the intermediate unit 230 are/is arranged between the connection unit 231 and the drive apparatus 233, in particular its drive head 233E. Mostly preferred, the intermediate unit 230 is arranged between the connection unit 231 and clamping unit 232.

As already mentioned, the analyzer 200, in particular the clamping system 280, preferably comprises a mounting frame/rack 237, hereinafter referred to as rack 237, preferably wherein some or all parts of the clamping system 280, in particular the intermediate unit 230, the connection unit 231, the clamping unit 232, the drive apparatus 233, the guide apparatus 234, the lifting apparatus 238 and/or the opening apparatus 239 are (directly) mounted on and/or (rigidly/immovably) attached to the rack 237.

In the present embodiment, the connection unit 231, the drive apparatus 233, the guide apparatus 234, the lifting apparatus 238 and the opening apparatus 239 are directly mounted on and/or rigidly/immovably attached to the rack 237, whereas the clamping unit 232 and the intermediate unit 230 are movably attached to the rack 237, in particular via the guide apparatus 234.

The rack 237 preferably comprises at least one mounting surface 237A for mounting some or all parts of the clamping system 280, in particular the connection unit 231, the drive apparatus 233 and/or the guide apparatus 234. Mostly preferred, the rack 237 comprises at least one mounting surface 237A for the connection unit 231, at least one mounting surface 237A for the drive apparatus 233 and/or at least one mounting surface 237A for the guide apparatus 234.

Preferably, the connection unit 231, the guide apparatus 234, the lifting apparatus 238 and the opening apparatus 239 are connected to the rack 237, in particular its mounting surfaces 237A, in a force-fitting manner and/or by screwing.

The rack 237 preferably mechanically connects and/or holds/supports some or all parts of the clamping system 280, in particular the intermediate unit 230, the connection unit 231, the clamping unit 232, the drive apparatus 233, the guide apparatus 234, the lifting apparatus 238 and/or the opening apparatus 239.

Mostly preferred, the rack 237 is at least essentially flat and/or plate-like and/or comprises or defines a main extension plane.

The rack 237 preferably extends around and/or encompasses some or all parts of the clamping system 280, in particular the intermediate unit 230, connection unit 231, the clamping system 232, the drive apparatus 233, the guide apparatus 234, the lifting apparatus 238 and/or the opening apparatus 239.

The rack 237 is preferably rigid and/or made of metal, mostly preferred of aluminum.

Preferably, the rack 237 is harder/stiffer than the cushion 283.

As already mentioned, the analyzer 200, in particular the clamping system 280, preferably comprises a guide apparatus 234 for (movably/slidably) guiding/bearing the intermediate unit 230, connection unit 231 and/or clamping unit 232.

In the present embodiment, both, the clamping unit 232 and the optional intermediate unit 230, are driven/moved by means of the drive apparatus 233 and guided by means of the guide apparatus 234. However, it is also possible that only one of the units 230, 232, in particular the clamping unit 232, is driven/moved by means of the drive apparatus 233 and guided by means of the guide apparatus 234.

The connection unit 230 might additionally or alternatively be guided by means of the guide apparatus 234.

In the following, the movement/guidance primarily of the clamping unit 232 will be described. However, the intermediate unit 230 and—additionally or alternatively—the connection unit 231 can be driven/moved/guided in the same or a similar manner.

The guide apparatus 234 preferably holds/bears/guides the clamping unit 232, in particular in a movable/slidable manner and/or such that it can move/slide towards and away from the connection unit 231, mostly preferred within the rack 237.

The guide apparatus 234 preferably comprises/forms a (linear) guide track, on which the clamping unit 232 and/or the intermediate unit 230 are/is guided.

The guide apparatus 234 is preferably embodied as a linear-motion bearing and/or allows a linear movement of the intermediate unit 230 and/or the clamping unit 232 on a predefined track.

The intermediate unit 230 and/or the clamping unit 232 are/is preferably held/guided/beared on both/opposing sides and/or at the edges by means of the guide apparatus 234.

The guide apparatus 234 preferably comprises a plurality of guides, here two guides 234A, 234B, for movably/slidably guiding the intermediate unit 230 and/or clamping unit 232.

Preferably, the guide apparatus 234 comprises a first/main guide 234A, hereinafter referred to as first guide 234A, and a second/compensation guide 234B, hereinafter referred to as second guide 234B.

The guide apparatus 234 preferably comprises a plurality of rails/rods 234C, 234D and/or a plurality of bushes/slides/bearings 234E. The guide apparatus 234 preferably comprises and/or is formed by a first/main rail 234C, a second/compensation rail 234D, a first/main bush 234E and a second/compensation bush (not shown).

Mostly preferred, the first guide 234A comprises and/or is formed by the first rail 234C and the main bush 234E and/or the second guide 234B comprises and/or is formed by the second rails 234D and/or the compensation bush.

Preferably, the bushes 234E are movably/slidably attached to the corresponding rails 234C, 234D. In particular, the main bush 234E is movably/slidably attached to the first rail 234C and the compensation bush is movably/slidably attached to the second rail 234D.

The guide apparatus 234 might be equipped with further bushes that might also be embodied as main bushes 234E and/or compensation bushes.

The guides 234A, 234B, in particular the rails 234C, 234D, are preferably elongated and/or at least partially extend over the length of the analyzer 200, in particular its clamping system 280.

Preferably, the guides 234A, 234B, in particular the rails 234C, 234D, are bar/rod-shaped, have a round/circular section and/or are cylindrical. However, it is also possible that the rails 234C, 234D are embodied as profiled rails having a non-circular profile.

The guides 234A, 234B, in particular the rails 234C, 234D, are preferably arranged and/or integrated in the longitudinal sides of the rack 237. According to another preferred embodiment (not shown), the guides 234A, 234B, in particular the rails 234C, 234D, preferably form the longitudinal sides of the rack 237.

Preferably, the guides 234A, 234B, in particular the rails 234C, 234D, are arranged at least essentially parallel to one another, parallel to the longitudinal sides of the clamping system 280, in particular the rack 237, parallel to the shaft 233D of the drive apparatus 233 and/or on opposing sides of the rack 237.

The first guide 234A and/or first rail 234C preferably comprises/defines a first guide axis AG1, and/or the second guide 234B and/or the second rail 234D preferably comprises/forms a second guide axis AG2.

Preferably, the guide apparatus 234, in particular the guides 234A, 234B, rails 234C, 234D and/or the guide axes AG1, AG2, is/are arranged parallel to the main plane of the rack 237 and/or actuation axis AA of the drive apparatus 233 and/or at least essentially perpendicular to the main plane of the intermediate unit 230, the main plane of the connection unit 231, the main plane of the clamping unit 232 and/or the main plane H of the inserted cartridge 100.

The guide apparatus 234, in particular the guides 234A, 234B and/or rails 234C, 234D, is/are preferably mounted on and/or attached to the rack 237, in particular its mounting surface(s) 237A, and/or the connection unit 231.

The guides 234A, 234B, in particular the rails 234C, 234D, are preferably attached/mounted at one end on/to the rack 237, in particular its mounting surface(s) 237A, and/or attached/mounted at the other end on/to the connection unit 231.

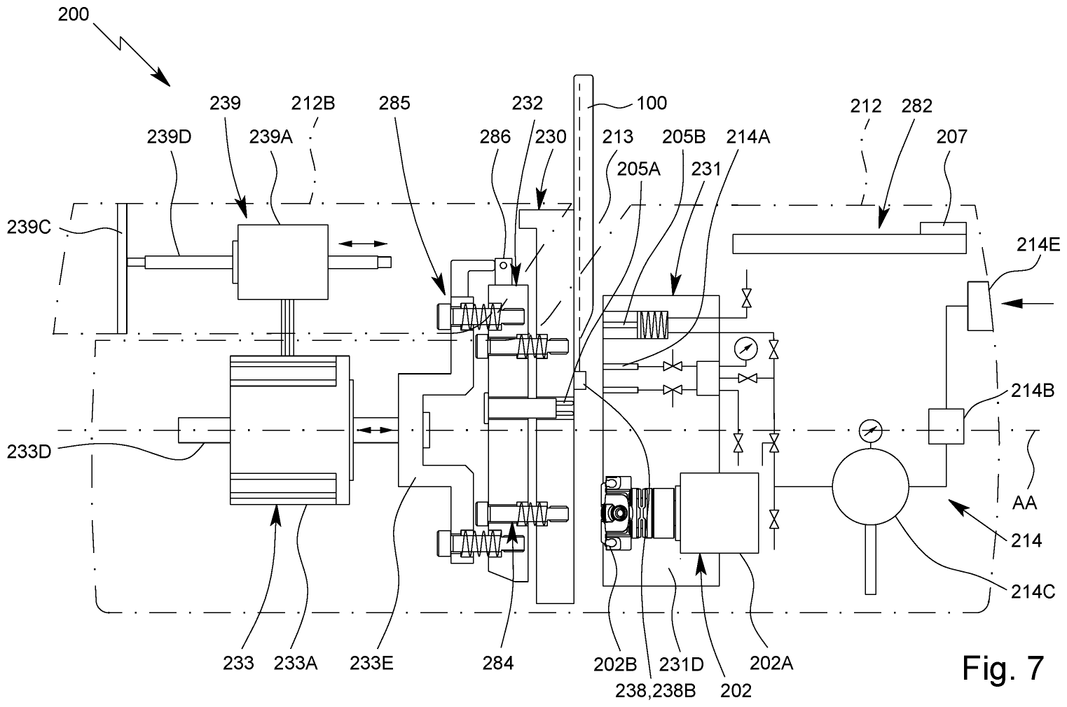

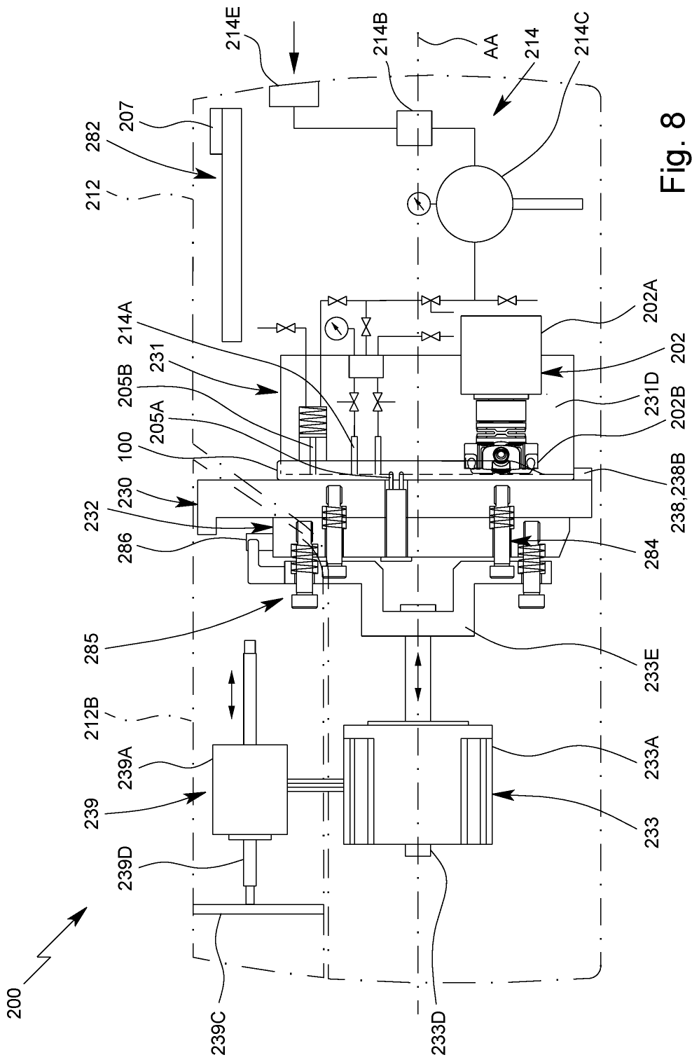

In the following the closing and opening mechanism/method of the analyzer 200 will be described with reference to FIGS. 7 and 8.

The closing and opening mechanism/method of the analyzer 200 is preferably conducted by means of the clamping system 280 and/or preferably comprises the steps of opening the analyzer 200 and/or the housing 212, receiving the cartridge 100, positioning/aligning the cartridge 100, clamping the cartridge 100, releasing the cartridge 100 and ejecting the cartridge 100.

The cartridge 100 and/or the clamping system 280, in particular the clamping unit 232, the intermediate unit 230 and/or the lifting apparatus 238, preferably change(s) its/their position/state during the closing and/or opening mechanism/method, preferably by means of the (common) drive apparatus 233.

In order to insert the cartridge 100 into the analyzer 200, the analyzer 200, in particular its housing 212, is preferably to be opened, in particular by means of the opening apparatus 239, as already mentioned.

The opening apparatus 239 is preferably adapted to open and/or close the analyzer 200, in particular the housing 212, mostly preferred by moving the access cover/housing part 212B.

The opening apparatus 239 preferably comprises an opening drive 239A, a shaft 239D and/or a preferably frame-like support 239C, which is also shown in FIG. 5.

The opening apparatus 239 is preferably embodied as a stepper-motor and/or comprises a preferably threaded spindle as shaft 239D.

The opening apparatus 239, in particular its shaft 239D, is preferably mechanically connected to the access cover/housing part 212B, in particular via the support 239C. Mostly preferred, the housing part 212B is mounted on the opening apparatus 239, in particular the support 239C, preferably in a form-fitting and/or force-fitting manner and/or by screwing.

The opening apparatus 239, in particular its drive 239A, is preferably (rigidly) attached to the clamping system 280 and/or rack 237.

By means of the opening apparatus 239, the access cover/housing part 212B can be moved preferably linearly and/or back and forth, in particular in order to open and close the analyzer 200, as indicated by arrows FIGS. 7 and 8.

The optional intermediate unit 230 is preferably adapted to receive, position, orientate and/or hold the cartridge 100, in particular between the clamping unit 232 and the connection unit 231, at least when being in the initial position.

Preferably, the intermediate unit 230 comprises the lifting apparatus 238. Mostly preferred, the lifting apparatus 238 is integrated into the intermediate unit 230 and/or moved together with the intermediate unit 230.

The lifting apparatus 238 is preferably adapted to receive the cartridge 100 and/or to move the cartridge 100 into and/or out of the analyzer 200, in particular the clamping system 280 and/or the intermediate unit 230 and/or the clamping unit 232.

The receiving direction of the cartridge 100 and/or the lifting movement of the lifting apparatus 238 preferably extend(s) transversally, in particular perpendicularly, to the direction of the actuation/closing/opening movement of the clamping system 280, in particular the clamping unit 232 and/or the intermediate unit 230, and/or to the actuation axis AA.

The intermediate unit 230 is preferably adapted to (directly) press the cartridge 100 against the connection unit 231, which is used in particular to mechanically, electrically, thermally and/or fluidically connect the cartridge 100 to the analyzer 200.

The clamping unit 232 is preferably adapted to position/align, orientate and/or hold the intermediate unit 230. Mostly preferred, the clamping unit 232 is adapted to position/align, orientate and/or hold the cartridge 100 by means of the intermediate unit 230 that is arranged between the clamping unit 232 and the cartridge 100.

Thus, the clamping unit 232 preferably (primarily) acts on the cartridge 100 in an indirect manner and/or by means of the intermediate unit 230.

Additionally and/or alternatively, the clamping unit 232 acts on the cartridge 100 in a direct manner. Mostly preferred, the clamping unit 232 is adapted to (directly) actuate, in particular open, one or more valves 115A of the cartridge 100.

In particular, the clamping unit 232 comprises or forms the actuator(s) 205A for actuating, in particular opening, one or more valves 115A of the cartridge 100, as will be described later.

In the present embodiment, the clamping unit 232 acts both directly and indirectly, i.e. via the intermediate unit 230, on the cartridge 100. However, it is also possible that either the clamping unit 232 or the intermediate unit 230 solely acts on the cartridge 100 in a direct manner.

FIG. 7 shows analyzer 200, i.e. its housing 212, in the open state/position, the clamping system 280, in particular the clamping unit 232 and/or the intermediate unit 230, in the initial position and the lifting apparatus 238 in the transfer position.

The open state/position of the analyzer 200 is preferably the position, in which the opening 213 is formed and/or the receptacle 201 is accessible and/or in which the lifting apparatus 238 is in the transfer position and/or in which the cartridge 100 can be inserted into and/or removed from the analyzer 200, in particular the clamping system 280, the intermediate unit 230, the lifting apparatus 238 and/or the receptacle 201.

The transfer position of the lifting apparatus 238 is preferably the position in which the lifting apparatus 238 is ready to receive a (new) cartridge 100 and/or to move a (new) cartridge 100 into the analyzer 200 and/or in which a (used) cartridge 100 is ejected or can be removed from the analyzer 200. Preferably, a retaining element 238B of the lifting apparatus 238 has been completely moved upwards in the transfer position of the lifting apparatus 238, in particular such that the cartridge 100 projects out of the analyzer 200 or its housing 212 or opening 213 and/or can be grabbed, as shown in FIG. 7.

The initial/receiving position of the clamping system 280, in particular the clamping unit 232 and/or the intermediate unit 230, is preferably the position, in which the lifting apparatus 238 can be used and/or in which the cartridge 100 can be inserted into and/or received by and/or ejected/removed from the clamping system 280, in particular the clamping unit 232 and/or the intermediate unit 230, mostly preferred by means of the lifting apparatus 238.

Preferably, the distance between the clamping unit 232 and/or the intermediate unit 230 on the one hand and the connection unit 231 on the other hand is maximized and/or the clamping unit 232 and/or the intermediate unit 230 are/is moved away from the connection unit 231 in the initial/receiving position.

FIG. 8 corresponds to FIG. 7, but shows the lifting apparatus 238 in the end position. The housing 212 of the analyzer 200 is (already) closed. The clamping unit 232 and the intermediate unit 230 are in the test position.

The end position of the lifting apparatus 238 is preferably the position in which the lifting apparatus 238 has received/lowered the cartridge 100 completely. Preferably, the retaining element 238B of the lifting apparatus 238 has been completely moved downwards into the end position of the lifting apparatus 238, in particular such that the cartridge 100 does not project out of the analyzer 200 or its housing 212 or opening 213 and/or that the analyzer 200, in particular its housing 212, can be closed without interfering with the cartridge 100.

Preferably, the test position is the position in which the clamping unit 232, the intermediate unit 232 and the cartridge 100 have been moved together towards the connection unit 232. In particular, the clamping unit 232 and the intermediate unit 230 have been moved out of the initial position towards the connection unit 231 until the cartridge 100 is clamped between the clamping unit 232 and/or the intermediate unit 230 on the one hand and the connection unit 231 on the other hand.

The test position of the clamping system 280, in particular the clamping unit 232 and/or the intermediate unit 230, is preferably the position, in which the intermediate unit 232 abuts and/or is completely moved towards and/or pressed against the cartridge 100 and/or in which the cartridge 100 abuts and/or is completely moved towards and/or positioned/pressed against the connection unit 231.

Preferably, the cartridge 100 is immovably held between the clamping unit 232 and/or the intermediate unit 230 on the one hand and the connection unit 231 on the other hand in the test position. Mostly preferred, the distance between the intermediate unit 230 and the connection unit 231 is minimized in the test position.

Mostly preferred, a plurality or all of the (initially closed) valves 115A of the cartridge 100 are actuated, in particular forced open, preferably by means of the clamping unit 232 and/or one or more actuator apparatuses 205A in the test position and/or when the test position is reached.

Preferably, the clamping unit 232 and the intermediate unit 230 can be moved together in the first period of movement or first step and can be moved relative to one another in the movement direction in the second period of movement or second step, in particular in order to move the cartridge 100 towards the connection unit 231 and in particular also in order to open one or more valves 115A.

The test position of the clamping system 280, in particular the clamping unit 232 and/or the intermediate unit 230, is preferably the final position and/or the position, in which the distance between the drive head 233E of the drive apparatus 233 and the clamping unit 232 is minimized and/or in which the drive head 233E is completely moved towards and/or abuts the clamping unit 232 and/or in which the force exerted on the cartridge 100 is maximized.

Preferably, the test can (only) be conducted, when the test position is reached.

The intermediate unit 230 and/or the clamping unit 232 can preferably be moved out of the initial position into the test position or vice versa by means of the drive apparatus 233.

Once the cartridge 100 has been received and/or the lifting apparatus 238 is in the end position, the cartridge 100, the clamping unit 232 and/or the intermediate unit 230 containing the cartridge 100 are/is moved, in particular pushed, in a first step/period of movement, preferably towards the connection unit 231, in particular until the cartridge 100 abuts the connection unit 231 and/or is positioned on or against the connection unit 231 in the desired manner and/or until the cartridge 100 is clamped between the connection unit 231 and the intermediate unit 230 in the desired manner and/or until the test position has been reached.

The analyzer 200, in particular the clamping system 280, preferably comprises a first coupling/connection 284 for mechanically connecting the clamping unit 232 and the intermediate unit 230 to one another and an optional second coupling/connection 285 for mechanically connecting the intermediate unit 230 and the drive head 233E to one another.

The first coupling 284 is preferably arranged between the clamping unit 232 and the intermediate unit 230.

The second coupling 285 is preferably arranged or acts between the drive head 233E and the clamping unit 232.

Thus, the couplings 284, 285 are preferably arranged in series.

Preferably, the couplings 284 are flexible/yieldable/compressible, in particular in the direction of actuation.

The analyzer 200, in particular the clamping system 280, preferably comprises a detection apparatus 286, preferably wherein the detection apparatus 286 is adapted to detect the movement and/or position of the intermediate unit 230, the connection unit 231, the clamping unit 232 and/or the drive head 233E, in particular relative to one another, and/or if the test position has been reached.

Mostly preferred, the detection apparatus 286 is adapted to (directly) detect the compression of the second coupling 285, in particular its coupling spring, and/or if a predefined spring deflection has been reached.

Preferably, the drive apparatus 233 is stopped by means of the detection apparatus 286 and/or if the detection apparatus 286 detects the end position.

The detection apparatus 286 is preferably embodied as a photoelectric sensor and/or comprises a transmitter, a receiver and an optional reflector.

The detection apparatus 286 is preferably rigidly/immovably attached to the clamping unit 232, in particular the top thereof, in particular to directly detect the (predefined) spring deflection. However, it is also possible that the detection apparatus 286 is attached to other parts of the analyzer 200, in particular the drive head 233E, the connection unit 231, the intermediate unit 230 and/or the rack 237.

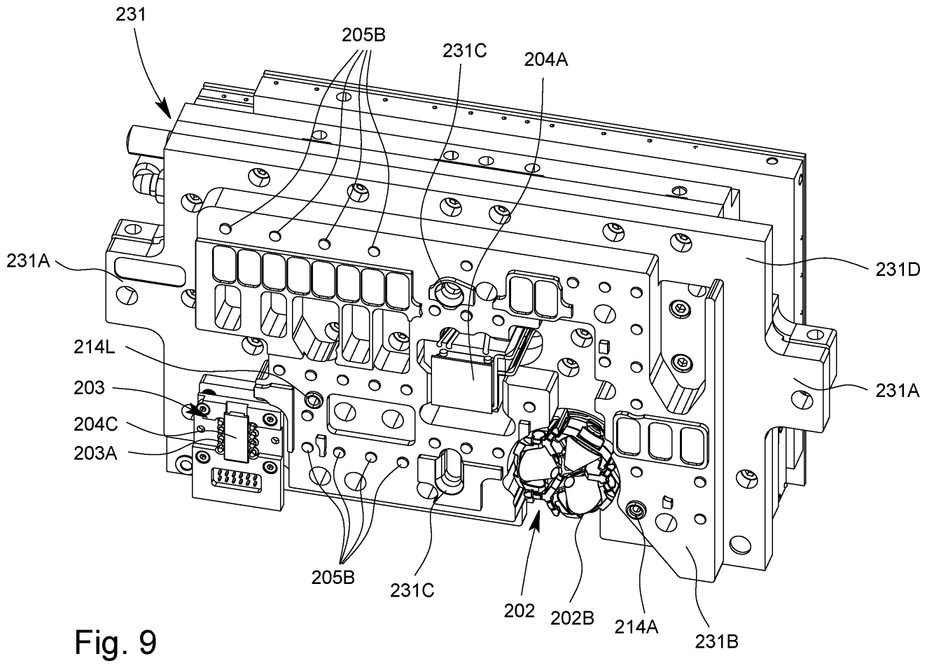

FIG. 9 is a schematic perspective view of the connection unit 231.

The connection unit 231 preferably forms an abutment or a contact surface for the cartridge, in particular its back 100B.

Preferably, the connection unit 231 comprises/forms a corresponding contact surface or support region 231B that supports the cartridge 100 in a clamped position and/or the test position.

The cartridge 100 is preferably positioned/orientated in a defined manner in the test position. This can be achieved in particular by means of corresponding engagement with the intermediate unit 230 and/or the connection unit 231.

In the example shown, the connection unit 231 preferably comprises at least one engagement portion 231C, which is designed in particular as a recess or depression, in order to receive an associated positioning portion 126 of the cartridge 100 in the test position and to thereby position the cartridge 100 in its main plane H.

Particularly preferably, two engagement portions 231C are formed on the connection unit 231 that interact with the two positioning portions 126 of the cartridge 100 and/or engage in or with the two positioning portions 126 in the test position.

Particularly preferably, one engagement portion 231C, in this case the lower engagement portion 231C, is in the form of a slot or an oblong hole, whereas the other, in this case the upper, engagement portion 231C, is in the form of a circular hole. This provides for optimum positioning, reducing the risk of canting/jamming.

The connection unit 231 preferably comprises lateral bearing portions 231A for the guide apparatus 234, in particular for receiving or bearing the guide apparatus 234, in particular the first rail 234C and the second rail 234D.

The connection unit 231 holds or comprises preferably one or more temperature-control apparatuses 204, in this case in particular a (further) reaction temperature-control apparatus 204A and/or the sensor temperature-control apparatus 204C.

The reaction temperature-control apparatus 204A of the connection unit 231 is preferably opposite the reaction temperature-control apparatus 204A of the intermediate unit 230.

Thus, the cartridge 100 and/or one or more reaction cavities 109 thereof are preferably received, arranged and/or clamped between said two temperature-control apparatuses 204A, in particular such that the temperature-control apparatuses 204A are positioned against or about the cartridge 100 from opposing sides in the region of the reaction cavity/cavities 109.

This allows the reaction cavity/cavities 109 to be temperature-controlled in an optimal manner.

However, also other solutions are possible here, in which only one reaction temperature-control apparatus 204A is provided either on the intermediate unit 230 or the connection unit 231.

One of the two temperature-control apparatuses 204A is preferably floatingly mounted and/or resiliently preloaded such that it is ensured that the temperature-control apparatuses 204A are positioned against the cartridge 100 in an effective and/or reliable manner and/or over the entire surface thereof and, thus, good thermal coupling is also ensured.

In particular, the temperature-control apparatus 204A of the connection unit 231 protrudes towards the cartridge 100 such that the temperature-control apparatus 204A engages in the recess, depression or region 101E of reduced wall thickness of the cartridge 100. The reduction in wall thickness of the main body 101 in the region of the reaction cavity/cavities 109 is advantageous in that it allows improved thermal coupling and/or reduces the thermal resistance between the temperature-control apparatus 204A and a fluid in the reaction cavity 109.

The reaction cavities 109 also preferably have a very small cross section perpendicularly to the main plane H, i.e. the cross section of said cavities is very flat and said cavities have a surface extension that is at least substantially parallel to the main plane H, and therefore the height of said cavities 109 is low perpendicularly to the main plane H. This allows good thermal coupling between the fluid in the reaction cavities 109 and the temperature-control apparatuses 204A.

The sensor temperature-control apparatus 204C shown in FIG. 9 is preferably arranged and/or preferably projects such that, in the test position, the sensor apparatus 113 and/or a central region 113H between the contacts 113E is positioned against or abuts the sensor temperature-control apparatus 204C. This produces a thermal coupling in order to temperature-control, in the desired manner, a sensor compartment and fluids located therein and reactions, in particular such that heat is transferred from the sensor temperature control apparatus 204C through the sensor apparatus 113 to a sensor compartment and fluids located therein, or vice versa.

The connection apparatuses 203 or the contact elements 203A thereof are arranged in particular around the temperature-control apparatus 204C in order to electrically connect or contact the sensor apparatus 113 or the contacts 113E thereof.

The connection unit 231 preferably supports one, a plurality or all of the actuator apparatuses 205B for actuating the assigned (normally open) valves 115B of the cartridge 100. It can be seen from FIG. 9 that a plurality of actuator apparatuses 205B are provided that can act on the cartridge 100 as required.

The actuator apparatuses 205B are integrated in particular in a main body 231D of the connection unit 231. In the example shown, the main body 231D is preferably constructed or assembled from a plurality of plates or plate-shaped components.

The connection unit 231 preferably supports or holds the pump drive 202. In particular, the pump drive 202 is also integrated in the main body 231D, as shown in FIGS. 7 to 9.

In particular, a motor 202A of the pump drive 202 drives a pump head 202B of the pump drive 202.

The pump drive 202 and/or pump head 202B points towards the cartridge 100 and/or towards the intermediate unit 230, and therefore the pump head 202B can act on the pump apparatus 112 of the cartridge 100 in the desired manner in the test position. In particular, a fluid (gas or liquid) can be conveyed in the pump apparatus 112 and, thus, in the cartridge 100 by rotating the pump head 202B. The pumping is thus controlled by operating the pump drive 202 and/or pump motor 202A accordingly.

The pump drive 202 or the pump motor 202A thereof and the temperature-control apparatuses 204 are preferably operated electrically and in particular supplied with electrical power by the power supply 211 and/or controlled by the control apparatus 207.

Preferably, a plurality of apparatuses of the analyzer 200, such as the actuator apparatuses 205B, and/or a plurality of apparatuses of the cartridge 100, such as the pump apparatus 112 and the sensor apparatus 113, are supplied by the pressurized gas supply 214 and/or controlled and/or operated by the control apparatus 207 and/or by activating corresponding valves and correspondingly supplying pressurized gas, in particular air, from the pressurized gas supply 214.

The pressurized gas supply 214 will be described in the following with reference to FIG. 10, which shows a schematic diagram of the pressurized gas supply 214.

The analyzer 200, in particular the pressurized gas supply 214, preferably comprises at least one inlet 214D, at least one filter 214E, an inlet silencer 214F, an inlet gas storage 214G, a compressor 214B, a main gas storage 214C, a main pressure sensor 214H, an intermediate gas storage 214I, an intermediate pressure sensor 214J, at least one outlet silencer 214K, a first connection element 214A, a second connection element 214L, at least one actuator apparatus 205B, a plurality of pneumatic lines 214M, a discharge valve 288, a main valve 289, an intermediate valve 290, a throttle or throttle valve 291 and/or at least one, preferably a plurality of actuation valves 292-294, in particular a first actuation valve 292, a second actuation valve 293 and one or more third actuation valve(s) 294.

The filter 214E, the inlet silencer 214F, the inlet gas storage 214G, the compressor 214B, the main gas storage 214C, the main pressure sensor 214H, the intermediate gas storage 214I, the intermediate pressure sensor 214J, the outlet silencer(s) 214K, the connection elements 214A and 214L, the actuator apparatus(es) 205B, the discharge valve 288, the main valve 289, the intermediate valve 290, the throttle valve 291 and/or the actuation valve(s) 292-294 are preferably connected or connectable to one another fluidically, in particular pneumatically, and/or by means of the pneumatic lines 214M.

The pneumatic lines 214M are preferably embodied as (flexible) tubes and/or made out of plastic.

Preferably, the pneumatic lines 214M comprise a cross section that is smaller than the cross section of the main gas storage 214C and/or the intermediate gas storage 214I.

The compressor 214B, the main pressure sensor 214H, the intermediate pressure sensor 214J, the discharge valve 288, the main valve 289, the intermediate valve 290, the throttle valve 291 and/or the actuation valve(s) 292-294 are preferably electrically connected to and/or controlled/operated by the (common) control apparatus 207, as indicated by dashed lines in FIG. 10.

The pressurized gas supply 214 is preferably adapted to provide a pressurized working medium, preferably gas, in particular air.

Preferably, at least one apparatus 112, 113, 205B of the analyzer 200 and/or the cartridge 100 is operated/powered pneumatically and/or with/by compressed/pressurized air and/or by means of the pressurized gas supply 214.

Mostly preferred, the pump apparatus 112, the sensor apparatus 113, the actuator apparatus(es) 205B for the (normally open) valves 115B, the drive apparatus 233, the lifting apparatus 238 and/or the opening apparatus 239 are/is powered/operated pneumatically and/or with/by compressed air and/or by means of the pressurized gas supply 214.

The pressurized gas supply 214 is preferably adapted to supply pressurized/compressed air to the cartridge 100, in particular the pump apparatus 112 and/or the sensor apparatus 113, and/or to the clamping system 280, in particular the connection unit 231 and/or the actuator apparatus(es) 205B.

The pressurized gas supply 214 is preferably integrated in the analyzer 200 or its housing 212.

The pressurized gas supply 214, in particular its compressor 214B, is preferably operated electrically and/or by means of electrical power. In particular, the pressurized gas supply 214, preferably the compressor 214B, can be supplied with electrical power by means of the electrical power supply 211 (not shown in FIG. 10).

The analyzer 200, in particular its pressurized gas supply 214, is preferably embodied as an open circuit. Mostly preferred, the pressurized gas supply 214 is integrated in an open circuit for the working medium. However, other solutions are possible as well, in particular wherein the analyzer 200, mostly preferred its pressurized gas supply 214, comprises or forms and/or is integrated in a closed circuit.

The analyzer 200, in particular its pressurized gas supply 214, is preferably adapted to take in air from its surroundings and/or to use its surroundings as a reservoir for the working medium. However, it is also possible, that the analyzer 200, in particular the pressurized gas supply 214, comprises a preferably closed reservoir, such as a tank or container, for the working medium and/or is connected or connectable thereto.

Preferably, air can be drawn in through the inlet 214D and/or the filter 214E into the analyzer 200, in particular the pressurized gas supply 214.

The (air) inlet 214D of the analyzer 200, in particular the pressurized gas supply 214, is preferably embodied as an opening in the housing 212.

The filter 214E is preferably arranged within the inlet 214D and/or the housing 212.

The filter 214E is preferably embodied as a micro filter or a fine particulate filter, preferably wherein particles having a particle diameter of more than 10 micrometer or 5 micrometers can be separated by means of the filter 214E, preferably wherein the particle diameter is the maximum or average diameter of the respective particles.

The inlet silencer 214F and/or the inlet gas storage 214G are/is preferably adapted to reduce the noise of the analyzer 200, in particular the pressurized gas supply 214, preferably in or downstream of the inlet 214D and/or filter 214E.

The inlet silencer 214F is preferably fluidically arranged (directly) downstream of the inlet 214D and/or filter 214E and/or upstream of the compressor 214B and/or inlet gas storage 214G.

The optional inlet gas storage 214G preferably serves as a buffer between the compressor 214B on the one hand and the inlet 214D, filter 214E and/or inlet silencer 214F on the other hand.

The inlet gas storage 214G preferably comprises a volume of more than 5 ml or 10 ml, in particular of more than 15 ml, and/or less than 50 ml or 30 ml, in particular less than 25 ml.

The compressor 214B is preferably fluidically arranged between the main gas storage 214C on the one hand and the inlet 214D, filter 214E, inlet silencer 214F and/or inlet gas storage 214G on the other hand. Mostly preferred, the compressor 214B is located (directly) upstream of the main gas storage 214C.

The analyzer 200, preferably the pressurized gas supply 214, in particular the compressor 214B, is preferably adapted to compress air to a pressure of more than 100 kPa, in particular more than 150 kPa or 200 kPa, and/or less than 1 MPa or 500 kPa, in particular less than 400 kPa or 300 kPa, and/or to feed air to the main gas storage 214C at said pressure.

Thus, the pressure within the main gas storage 214C is preferably of more than 100 kPa, in particular more than 150 kPa or 200 kPa, and/or less than 1 MPa or 500 kPa, in particular less than 400 kPa or 300 kPa. Mostly preferred, the pressure within the main gas storage 214C is of at least essentially 200 kPa.

In particular, the main gas storage 214C is adapted to store compressed gas, in particular air, mostly preferred at said pressure.

The pressure and/or pressure values used within the context of the present invention preferably refer(s) to the absolute pressure and/or absolute pressure values, i.e. the pressure compared to (perfect) vacuum (0 kPa).

In contrast to the absolute pressure, the relative pressure is preferably the pressure compared to the ambient/atmospheric pressure, which is approximately 100 kPa at sea level.

Thus, an absolute pressure of 200 kPa preferably corresponds to a relative pressure of 100 kPa.

The main pressure sensor 214H is preferably adapted to measure the pressure in the main gas storage 214C and/or in the pneumatic line 214M between the main gas storage 214C and the main valve 289.

Preferably, the pressurized gas supply 214, in particular the compressor 214B, and/or the control apparatus 207, maintain(s) the pressure in the main gas storage 214C, in particular independently of the required load and/or the pressure in the intermediate gas storage 214I.

Mostly preferred, (only) the pressure in the intermediate gas storage 214I is controlled/adapted, preferably by means of the control apparatus 207, the intermediate valve 290, the throttle valve 291 and/or the actuation valve(s) 292-294 and/or according to the required load and/or the apparatus 112, 113 and/or 205B to be activated/deactivated and/or used.

The main gas storage 214C is preferably fluidically arranged downstream of the compressor 214B and/or upstream of the main valve 289, the intermediate valve 290, the intermediate gas storage 214I and/or the actuation valve(s) 292-294.

The main gas storage 214C is preferably larger than the inlet gas storage 214G and/or the intermediate gas storage 214I and/or comprises a volume or filling capacity of more than 20 ml or 30 ml, in particular of more than 50 ml or 80 ml, and/or less than 500 ml or 300 ml, in particular less than 200 ml or 150 ml.

Mostly preferred, the main gas storage 214C comprises a volume or filling capacity of 100 ml.

The discharge valve 288 is preferably arranged directly downstream of the main gas storage 214C.

The discharge valve 288 is preferably adapted to decrease the pressure in the main gas storage 214C, in particular to atmosphere pressure, mostly preferred when being opened.

The discharge valve 288 is preferably adapted to fluidically connect/disconnect the assigned/associated outlet silencer 214K to/from the main gas storage 214C, in particular in order to reduce the pressure in the main gas storage 214C.

The main valve 289 is preferably fluidically arranged between the main gas storage 214C on the one hand and the intermediate valve 290 and/or the third actuation valve(s) 294 on the other hand.

The intermediate valve 290 is preferably adapted to fluidically connect/disconnect the main gas storage 214C to/from the intermediate valve 290, the throttle valve 291, the intermediate gas storage 214I, the first actuation valve 292, the second actuation valve 293 and/or the third actuation valve(s) 294.

The intermediate gas storage 214I is preferably arranged downstream of the main gas storage 214C, the compressor 214B, the inlet gas storage 214G, the inlet silencer 214F, the filter 214E and/or the inlet 214D.

The intermediate gas storage 214I is preferably smaller than the main gas storage 214C and/or the inlet gas storage 214G.

Preferably, the intermediate gas storage 214I comprises a volume or filling capacity of more than 1 ml or 2 ml, in particular more than 3 ml or 4 ml and/or less than 20 ml or 15 ml, in particular less than 10 ml or 8 ml.

Mostly preferred, the intermediate gas storage 214I comprises a volume or filling capacity of 5 ml.

The intermediate pressure sensor 214J is preferably adapted to measure the pressure in the intermediate gas storage 214I and/or in the pneumatic line 214M between the intermediate gas storage 214I and the actuation valve(s) 292-294.

The pressure in the intermediate gas storage 214I is preferably lower than the pressure in the main gas storage 214C.

Preferably, the pressure in the intermediate gas storage 214I is of more than 100 kPa, in particular more than 120 kPa, and/or less than 200 kPa, in particular less than 190 kPa.

The intermediate gas storage 214I is preferably adapted to store compressed gas, in particular air, preferably at said pressure.

Mostly preferred, the pressure in the intermediate gas storage 214I is changed within the range of 100 kPa and 200 kPa and/or dependent on the (required) load and/or the apparatus 112, 113 and/or 205B to be activated/deactivated and/or used and/or pressurized and/or supplied with pressurized air.

The pressure in the intermediate gas storage 214I is preferably increased by means of the intermediate valve 290, in particular by opening the intermediate valve 290, and/or by fluidically connecting the main gas storage 214C to the intermediate gas storage 214I.

The intermediate valve 290 is preferably adapted to fluidically connect/disconnect the main gas storage 214C to/from the intermediate gas storage 214I.

The intermediate valve 290 is in particular adapted to selectively fluidically connect and disconnect the main gas storage 214C to and from the intermediate gas storage 214I, in particular in order to increase the pressure within the intermediate gas storage 214I.

The intermediate valve 290 is preferably fluidically arranged between the main gas storage 214C and the intermediate gas storage 214I. In particular, the intermediate valve 290 is arranged downstream of the main gas storage 214C and/or the main valve 289 and/or upstream to the throttle valve 291 and/or the intermediate gas storage 214I.

The throttle or throttle valve 291, in the following referred to as throttle valve 291, is preferably (directly) arranged downstream of the intermediate gas storage 214I and/or is adapted to regulate the flow to and/or the pressure in the intermediate gas storage 214I.

Preferably, the throttle valve 291 is embodied as a flow-control valve and/or pressure reducing valve.

The throttle valve 291 is preferably adapted to reduce the flow area locally and/or to reduce the supply pressure and/or the pressure supplied by the compressor 214B and/or the main gas storage 214C, in particular to a target pressure and/or the pressure in the intermediate gas storage 214I.

Preferably, the throttle valve 291 is adapted to increase the flow resistance locally.

In particular, the throttle valve 291 is embodied as a local reduction of the flow area, preferably in the pneumatic line 214M supplying the intermediate gas storage 214I.

Optionally, the throttle valve 291 can be controlled, in particular by means of the control apparatus 207. In this way, the flow area provided by the throttle valve 291 can be changed.

However, the throttle valve 291 might be embodied as a constant and/or unchangeable (local) reduction of the flow area.

The pressure in the intermediate gas storage 214I is preferably reduced by fluidically connecting the intermediate gas storage 214I to an outlet and/or an outlet silencer 214K of the pressurized gas supply 214 and/or means of the first actuation valve 292 and/or the second actuation valve 293.

In particular, the first actuation valve 292 and/or the second actuation valve 293 are/is adapted to fluidically connect the intermediate gas storage 214I to an outlet and/or an outlet silencer 214K of the pressurized gas supply 214.

Thus, the first actuation valve 292 and/or the second actuation valve 293 preferably act(s) and/or are/is preferably used as a discharge valve. However, it is also possible, that the analyzer 200, in particular the pressurized gas supply 214, comprises an additional discharge valve for the intermediate gas storage 214I.

The actuation valve(s) 292, 293 are/is preferably arranged (directly) downstream of the intermediate gas storage 214I.

The first actuation valve 292 is preferably fluidically arranged downstream of the intermediate gas storage 214I, in particular directly.

The first actuation valve 292 is preferably adapted to fluidically connect/disconnect at least one apparatus 112, 113, 205B, in particular the pump apparatus 112, to/from the intermediate gas storage 214I.

The first actuation valve 292 is in particular adapted to selectively fluidically connect and disconnect at least one apparatus 112, 113, 205B, in particular the pump apparatus 112, to and from the intermediate gas storage 214I.

With other words, the first actuation valve 292 is preferably associated/assigned with/to the pump apparatus 112.

The second actuation valve 293 is preferably fluidically arranged downstream of the first actuation valve 292 and/or the intermediate gas storage 214I.

The second actuation valve 293 is preferably adapted to fluidically connect/disconnect at least one apparatus 112, 113, 205B, in particular the sensor apparatus 113, to/from the intermediate gas storage 214I.

The second actuation valve 293 is in particular adapted to selectively fluidically connect and disconnect at least one apparatus 112, 113, 205B, in particular the sensor apparatus 113, to and from the intermediate gas storage 214I.

With other words, the second actuation valve 293 is preferably associated/assigned with/to the sensor apparatus 113.

In the present embodiment, the actuation valves 292, 293 are preferably arranged in series, preferably wherein the second actuation valve 293 is arranged (directly) downstream of the first actuation valve 292 and/or wherein the first actuation valve 292 is fluidically arranged between the intermediate gas storage 214I and the second actuation valve 293. However, it is also possible to arrange the actuation valves 292, 293 in parallel, in particular such that both, the first actuation valve 292 and the second actuation valve 293, are arranged directly downstream of the intermediate gas storage 214I.

The optional third actuation valve 294 is preferably assigned to at least one apparatus 112, 113, 205B, in particular the actuator apparatus 205B.

The third actuation valve 294 is preferably adapted to fluidically connect/disconnect at least one apparatus 112, 113, 205B, in particular the actuator apparatus 205B, to/from the main gas storage 214C.

The third actuation valve 294 is in particular adapted to selectively fluidically connect and disconnect at least one apparatus 112, 113, 205B, in particular the actuator apparatus 205B, to and from the main gas storage 214C.

Preferably, the third actuation valve 294 is fluidically arranged upstream of the actuator apparatus 205B and/or (directly) downstream of the main valve 289.

The third actuation valve 294 is preferably fluidically arranged in parallel to the intermediate valve 290, the throttle valve 291, the intermediate gas storage 214I, the first actuation valve 292 and/or the second actuation valve 293.

Thus, in contrast to the first actuation valve 292 and the second actuation valve 293, the third actuation valve 294 is preferably not supplied with air by the intermediate gas storage 214I, but rather (directly) by the main gas storage 214C.

The actuator apparatus 205B is preferably powered/supplied at/with a pressure that is higher than the pressure needed for the pump apparatus 112 and/or the sensor apparatus 113.

In particular, the actuator apparatus 205B is powered at a pressure that corresponds to the pressure in the main gas storage 214C.

The pump apparatus 112 and/or the sensor apparatus 113 are/is preferably powered at a pressure that corresponds to the pressure in the intermediate gas storage 214I.

The analyzer 200, in particular the pressurized gas supply 214, preferably comprises a plurality of third actuation valves 294 and/or actuator apparatuses 205B.

In the present embodiment, the analyzer 200, in particular the pressurized gas supply 214, comprises 32 third actuation valves 294 and 32 (associated) actuator apparatuses 205B.

In particular, the 32 actuator apparatus 205B are shown in FIG. 9. where only some of them are labeled. FIG. 10 shows by way of example one actuator apparatus 205B with its associate actuation valve 294.

Preferably, one actuation valve 294 is associated/assigned to a corresponding actuator apparatus 205B respectively.

In particular, one third actuation valve 294 and one actuator apparatus 205B are fluidically arranged and/or fluidically connected in series respectively.

The third actuation valves 294 are preferably fluidically arranged in parallel to one another.

The actuator apparatuses 205B are preferably fluidically arranged in parallel to one another.

In this context “in parallel” is preferably understood regarding the fluidic connection of the actuation valves 294 and/or actuator apparatuses 205B to one another and/or to the main gas storage 214C. However, the components need not be arranged physically in parallel in the analyzer 200.

All valves 288-294 are preferably directly or indirectly fluidically connected to an outlet of the pressurized gas supply 214 and/or an outlet silencer 214K.

Preferably, the discharge valve 288, the main valve 289, the second actuation valve 293 and/or the third actuation valve 294 are/is directly connected to an outlet and/or an outlet silencer 214K and/or are/is associated/assigned to and/or arranged (directly) upstream of an outlet and/or an outlet silencer 214K of the pressurized gas supply 214. However, other solutions are possible as well, in particular wherein several or all valves 288-294 are associated/assigned with/to a (common) outlet silencer 214K.

The outlet silencer(s) 214K is/are preferably adapted to reduce the noise of the analyzer 200, in particular the pressurized gas supply 214, mostly preferred in the outlet of the pressurized gas supply 214.

The outlet silencer(s) 214K are/is preferably arranged in the outlet of the pressurized gas supply 214 and/or (each) comprises or forms an outlet of the pressurized gas supply 214.

As already explained, the analyzer 200 is preferably pneumatically connected or connectable to the cartridge 100, mostly preferred by means of the connection unit 231 and/or the connection element(s) 214A, 214L.

Preferably, the first connection element 214A is associated with a first connection 129 of the cartridge 100 and the second connection element 214L is associated with a different or second connection 129 of the cartridge 100, as shown in FIG. 3.

The connection element(s) 214A, 214L is/are preferably adapted to pneumatically connect the cartridge 100 to the analyzer 200, in particular its connection unit 231 and/or pressurized gas supply 214.

Mostly preferred, the connection element(s) 214A, 214L are/is embodied as rigid tube(s) and/or hollow cylinder(s) and/or comprise(s) or form(s) an outlet of the pressurized gas supply 214.

Preferably, the connection element(s) 214A, 214L is/are held/supported by/in the connection unit 231, in particular its main body 231D, as best seen in FIG. 9.

Preferably, the connection element(s) 214A, 214L protrude through the connection unit 231, in particular its main body 231D, and/or out of the connection unit 231, in particular its contact surface for the cartridge 100, and/or towards the cartridge 100.

The pump apparatus 112 is preferably pneumatically connected to the analyzer 200, in particular the pressurized gas supply 214, mostly preferred the intermediate gas storage 214I, by means of the first connection element 214A.

The sensor apparatus 113 is preferably pneumatically connected to the analyzer 200, in particular the pressurized gas supply 214, mostly preferred the intermediate gas storage 214I, by means of the second connection element 214L.

In the following, the construction and/or functionality of the discharge valve 288, the main valve 289, the intermediate valve 290, the throttle valve 291, the first actuation valve 292, the second actuation valve 293 and/or the third actuation valve(s) 294 will be described.

When not explicitly mentioned, the following description applies to the discharge valve 288, the main valve 289, the intermediate valve 290, the throttle valve 291, the first actuation valve 292, the second actuation valve 293 and/or the third actuation valve(s) 294. In particular, at least one, preferably several or all of the valves, in particular the discharge valve 288, the main valve 289, the intermediate valve 290, the throttle valve 291, the first actuation valve 292, the second actuation valve 293 and/or the third actuation valve 294, is/are meant when the term “valve(s) 288-294” is used.

The valve(s) 288-294 is/are preferably embodied as directional control valve(s), in particular three-way two-position (3W/2P or 3/2) directional control valve(s) and/or switch valve(s).

Preferably, the valve(s) 288-294 is/are adapted to switch between several, in particular two, positions, in particular an initial/unactuated position and an end/actuated position, and/or to change the fluid flow between the valve ports and/or the pneumatic lines 214M directly connected thereto, in particular by moving a valve body back and forth and/or from an initial position to an end position or vice versa.

Preferably, the valve(s) 288-294 comprise(s) several, in particular three, ports, preferably wherein the ports are selectively fluidically connected and disconnected to and from one another by activating or deactivating the valve(s) 288-294 and/or by changing the valve position, in particular by moving a valve body back and forth and/or from an initial position to an end position or vice versa.

FIG. 10 shows the valves 288-294 in their initial/unactuated/deactivated state/position and/or in the state/position they are normally in, e.g. when not being activated/actuated.

The initial position/state of the valve(s) 288-294 is preferably the position/state of the valve(s) 288-294 and/or its/their valve body when being unactuated/deactivated, e.g. by means of an associated or integrated actuator.

Preferably, the initial position of the valve(s) 288-294 and/or its/their valve body is the normal position.

Mostly preferred, the valve(s) 288-294, in particular its/their valve body, automatically return(s) to the initial position, after deactivation and/or when being unactuated/deactivated, in particular due to an associated or integrated return mechanism, as will be explained later.

The end position/state of the valve(s) 288-294 and/or its/their valve body is preferably the position/state of the valve(s) 288-294 and/or its/their valve body when being (completely) actuated/activated, e.g. by means of an associated or integrated actuator. Thus, the end position of the valve(s) 288-294 is preferably only a temporary position.

Preferably, the position of the valve(s) 288-294 and/or its/their valve body can be changed by actuating/activating or unactuating/deactivating the valve(s) 288-294.

Preferably, the initial position and/or unactuated/deactivated position of the valve(s) 288-294 and/or its/their valve body can be changed to the end position and/or actuated/activated position of the valve(s) 288-294 and/or its/their valve body by actuating/activating the valve(s) 288-294.

Accordingly, the end position and/or actuated/activated position of the valve(s) 288-294 and/or its/their valve body can be changed to the initial position and/or unactuated/deactivated position of the valve(s) 288-294 and/or its/their valve body by unactuating/deactivating the valve(s) 288-294.

By changing the positions, the fluid connections of the ports of the valve(s) 288-294 are changed. For example, in the initial position a first port and a second port of the valve(s) 288-294 are fluidically connected, whereas in the end position the first port and the second port are fluidically disconnected and/or the first port or second port is fluidically connected to a third port of the valve(s) 288-294.

During the position change, i.e. when switching from the initial position to the end position or vice versa, the valve(s) 288-294 is/are temporarily in an intermediate position/state.

The intermediate position of the valve(s) 288-294 and/or its/their valve body is preferably the position/state of the valve(s) 288-294 and/or its/their valve body between the initial position and the end position and/or immediately after being actuated/activated or unactuated/deactivated and/or before reaching the end position or the initial position.

In the intermediate position, all ports of the valve(s) 288-294 might be fluidically connected to or disconnected from one another.

The valve(s) 288-294 are preferably mechanically, hydraulically, electrically and/or electromechanically, mostly preferred electromagnetically, actuated/activated, as will be explained later.

Preferably, the discharge valve 288 is open and/or fluidically connects the assigned/associated outlet silencer 214K and/or an outlet to the main gas storage 214C normally and/or when being unactuated/deactivated and/or in its initial position.

In particular, the discharge valve 288 fluidically disconnects the assigned/associated outlet silencer 214K and/or an outlet from the main gas storage 214C when being activated/actuated and/or in its end position.

The main valve 289 preferably fluidically disconnects the main gas storage 214C from the intermediate valve 290, the throttle valve 291, the intermediate gas storage 214I, the first actuation valve 292, the second actuation valve 293 and/or the third actuation valve(s) 294 normally and/or when being deactivated/unactuated and/or in its initial position.

The main valve 289 preferably fluidically connects an outlet of the pressurized gas supply 214 and/or an outlet silencer 214K to the intermediate valve 290, the throttle valve 291, the intermediate gas storage 214I, the first actuation valve 292, the second actuation valve 293 and/or the third actuation valve(s) 294 normally and/or when being deactivated/unactuated and/or in its initial position.

The main valve 289 preferably fluidically connects the main gas storage 214C to the intermediate valve 290, the throttle valve 291, the intermediate gas storage 214I, the first actuation valve 292, the second actuation valve 293 and/or the third actuation valve(s) 294 when being activated/actuated and/or in its end position.

The main valve 289 preferably fluidically disconnects an outlet of the pressurized gas supply 214 and/or an outlet silencer 214K from the intermediate valve 290, the throttle valve 291, the intermediate gas storage 214I, the first actuation valve 292, the second actuation valve 293 and/or the third actuation valve(s) 294 when being activated/actuated and/or in its end position.

The intermediate valve 290 preferably fluidically disconnects the main gas storage 214C and/or the main valve 289 from the throttle valve 291, the intermediate gas storage 214I, the first actuation valve 292 and/or the second actuation valve 293 normally and/or when being deactivated/unactuated and/or in its initial position.

The intermediate valve 290 preferably fluidically connects the main gas storage 214C and/or the main valve 289 to the throttle valve 291, the intermediate gas storage 214I, the first actuation valve 292 and/or the second actuation valve 293 when being activated/actuated and/or in its end position.

The first actuation valve 292 preferably fluidically connects the first connection element 214A and/or the pump apparatus 112 to the main gas storage 214C, the main valve 289, the intermediate valve 290, the throttle valve 291 and/or the intermediate gas storage 214I normally and/or when being deactivated/unactuated and/or in its initial position.

The first actuation valve 292 preferably fluidically disconnects the second connection element 214L, the sensor apparatus 113 and/or the second actuation valve 293 from the main gas storage 214C, the main valve 289, the intermediate valve 290, the throttle valve 291 and/or the intermediate gas storage 214I normally and/or when being deactivated/unactuated and/or in its initial position.

The first actuation valve 292 preferably fluidically disconnects the first connection element 214A and/or the pump apparatus 112 from the main gas storage 214C, the main valve 289, the intermediate valve 290, the throttle valve 291 and/or the intermediate gas storage 214I when being activated/actuated and/or in its end position.

The first actuation valve 292 preferably fluidically connects the second connection element 214L, the sensor apparatus 113 and/or the second actuation valve 293 to the main gas storage 214C, the main valve 289, the intermediate valve 290, the throttle valve 291 and/or the intermediate gas storage 214I when being activated/actuated and/or in its end position.

The second actuation valve 293 preferably fluidically connects an outlet of the pressurized gas supply 214 and/or an associated outlet silencer 214K to the main gas storage 214C, the main valve 289, the intermediate valve 290, the throttle valve 291, the intermediate gas storage 214I and/or the first actuation valve 292 normally and/or when being deactivated/unactuated and/or in its initial position.

The second actuation valve 293 preferably fluidically disconnects the second connection element 214L and/or the sensor apparatus 113 from the main gas storage 214C, the main valve 289, the intermediate valve 290, the throttle valve 291, the intermediate gas storage 214I and/or the first actuation valve 292 normally and/or when being deactivated/unactuated and/or in its initial position.

The second actuation valve 293 preferably fluidically disconnects an outlet of the pressurized gas supply 214 and/or an associated outlet silencer 214K from the main gas storage 214C, the main valve 289, the intermediate valve 290, the throttle valve 291, the intermediate gas storage 214I and/or the first actuation valve 292 when being activated/actuated and/or in its end position.

The second actuation valve 293 preferably fluidically connects the second connection element 214L and/or the sensor apparatus 113 to the main gas storage 214C, the main valve 289, the intermediate valve 290, the throttle valve 291, the intermediate gas storage 214I and/or the first actuation valve 292 when being activated/actuated and/or in its end position.

It is preferred, that the sensor apparatus 113 and the pump apparatus 112 are actuated/pressurized, supplied with gas and/or fluidically connected to the intermediate gas storage 214I alternately and/or not simultaneously, in particular since the pump drive 202 and/or the fluid flow through the cartridge 100 is temporally stopped during the detection of the analyte or analytes of the sample P.

With other words, preferably either the sensor apparatus 113 or the pump apparatus 112 is actuated/pressurized, supplied with gas and/or fluidically connected to the intermediate gas storage 214I.

However, it is also possible to simultaneously actuate/pressurize the sensor apparatus 113 and the pump apparatus 112, in particular when the first actuation valve 292 and the second actuation valve 293 are fluidically arranged in series.

The third actuation valve(s) 294 preferably fluidically connect(s) the actuator apparatus(es) 205B to the main gas storage 214C and/or the main valve 289 normally and/or when being deactivated/unactuated and/or in their/its initial position.

The third actuation valve(s) 292 preferably fluidically disconnect(s) an associated outlet of the pressurized gas supply 214 and/or an associated outlet silencer 214K from the main gas storage 214C and/or the main valve 289 normally and/or when being deactivated/unactuated and/or in their/its initial position.

The third actuation valve(s) 294 preferably fluidically disconnect(s) the actuator apparatus(es) 205B from the main gas storage 214C and/or the main valve 289 when being activated/actuated and/or in their/its end position.

The third actuation valve(s) 292 preferably fluidically connect(s) an associated outlet of the pressurized gas supply 214 and/or an associated outlet silencer 214K to the main gas storage 214C and/or the main valve 289 when being activated/actuated and/or in their/its end position.

As already mentioned, the valve(s) 288-294 is/are preferably mechanically, hydraulically, electrically and/or electromechanically, mostly preferred electromagnetically, operated/actuated.

Preferably, the valve(s) 288-294 (each) comprise(s) a preferably integrated valve actuator 288A-294A, preferably wherein the associated valve actuator 288A-294A is adapted to actuate, in particular selectively activate or deactivate, the valve 288-294, in particular its valve body, and/or to change its position and/or to switch the valve 288-294, i.e. from the deactivated/unactuated position into the activated/actuated position or vice versa.

In FIG. 10, the valve actuator of the throttle valve 291 is not shown. However, the valve actuator of the throttle valve 291 might be identical or similar to one of the valve actuators 288A-294A of the other valves 288-294.

In the present embodiment, the valve(s) 288-294 is/are electrically, in particular electromagnetically/solenoid, operated and/or comprise(s) a solenoid as valve actuator 288A-294A.

Thus, the valve(s) 288-294 is/are preferably embodied as solenoid valves.

Preferably, the valve(s) 288-294 is/are actuated/activated and/or the position of the valve(s) 288-294 and/or its/their valve body is changed, in particular from the initial and/or deactivated position to the end and/or activated position, by activating/powering/energizing the valve actuator(s) 288A-294A.

Preferably, the valve(s) 288-294 is/are unactuated/deactivated and/or the position of the valve(s) 288-294 and/or its/their valve body is changed, in particular from the end and/or activated position to the initial and/or deactivated position, by deactivating/deenergizing the valve actuator(s) 288A-294A.

Preferably, the valve(s) 288-294 and/or its/their valve body return(s) into its/their initial position/state automatically and/or when being deactivated/unactuated and/or when the valve actuator(s) 288A-294A is/are deactivated/deenergized.

Preferably, the valve(s) 288-294 (each) comprise(s) a preferably integrated return mechanism 288B-294B, preferably wherein the return mechanism 288B-294B is adapted to move the associated valve 288-294, in particular its valve body, into the initial position, at least when being deactivated/unactuated and/or when the valve actuator(s) 288A-294A is/are deactivated/deenergized.

Mostly preferred, the valve(s) 288-294 and/or its/their valve body is/are pretensioned into the initial position.

Preferably, the valve(s) 288-294 (each) comprise(s) a return spring as return mechanism 288B-294B. However, other constructional solutions are possible as well.

As indicated by dashed lines, the valve(s) 288-294, in particular the valve actuators 288A-294A, is/are preferably electrically connected to the control apparatus 207.

Preferably, the analyzer 200, in particular its control apparatus 207, is adapted to control and/or activate/deactivate the valve(s) 288-294 and/or to change the position of the valve(s) 288-294 and/or to energize/deenergize the valve actuators 288A-294A, in particular as required and/or optionally and/or selectively and/or such that pressurized gas is supplied to the actuator(s) 205B, the pump apparatus 112 and/or the sensor apparatus 113 as required for the test.

The pressurized gas supply 214, in particular its compressor 214B, preferably draws in air from the surroundings, in particular via inlet 214D, filter 214E, inlet silencer 214F and/or inlet gas storage 214G.

The pressurized gas supply 214, in particular the compressor 214B, increases the pressure of the air, preferably to at least essentially 200 kPa, mostly preferred in the main gas storage 214C.

The pressure of the main gas storage 214C is preferably controlled, in particular by means of the control apparatus 207, the compressor 214B and/or the main pressure sensor 214H.

In particular by activating the main valve 289, the main storage 214C is fluidically connected to the intermediate valve 290 and/or the third actuation valve 294.

The pressure in the intermediate gas storage 214I is preferably controlled by means of the control apparatus 207, the intermediate valve 290, the throttle valve 291, the intermediate pressure sensor 214J, the first actuation valve 292 and/or the second actuation valve 293.

In particular in order to increase the pressure in the intermediate gas storage 214I, the intermediate valve 290 is activated and/or fluidically connects the main gas storage 214C to the throttle valve 291 and/or the intermediate gas storage 214I, preferably with the discharge valve 288 and the main valve 289 being activated as well.

The pressure in the intermediate gas storage 214I is preferably measured by means of the intermediate pressure sensor 214J.

The pressure in the intermediate gas storage 214I is preferably reduced by means of the first actuation valve 292 and/or the second actuation valve 293.

Preferably, the pump apparatus 112 and/or the sensor apparatus 113 are/is supplied with a constant pressure by means of the pressurized gas supply 214.

Preferably, the pressure in the intermediate gas storage 214I is maintained/kept at a (first) pressure level for the pump apparatus 112 and/or at a (second) pressure level for the sensor apparatus 113, preferably by means of the control apparatus 207, intermediate valve 290, the throttle valve 291, the first actuation valve 292 and/or the second actuation valve 293.

Preferably, when the pressure in the intermediate gas storage 214I drops below a predefined/required value, the intermediate valve 290 is activated and/or the intermediate gas storage 214I is fluidically connected to the main gas storage 214C, in particular by activating the intermediate valve 290. In this way, air can flow from the main gas storage 214C to the intermediate gas storage 214I.

Preferably, when the pressure in the intermediate gas storage 214 meets and/or is above a predefined/required value, the intermediate valve 290 is preferably deactivated and/or the intermediate gas storage 214I is fluidically disconnected from the main gas storage 214C, in particular by deactivating the intermediate valve 290.

With other words, the intermediate valve 290 is preferably selectively activated or deactivated in order to maintain the pressure in the intermediate gas storage 214I.

Preferably, the (target) pressure required for the actuation of the pump apparatus 112 differs from the (target) pressure required for the actuation of the sensor apparatus 113.

Preferably, the (first) pressure level and/or the (target) pressure for the pump apparatus 112, in particular for the actuation of the pump apparatus 112, is higher than the (second) pressure level and/or the (target) pressure for the sensor apparatus 113, in particular for the actuation of the sensor apparatus 113.

Preferably, the pressure in the intermediate gas storage 214I is adapted/changed according to the load and/or the apparatus 112, 113 to be activated.

When changing from the actuation of the pump apparatus 112 to the actuation of the sensor apparatus 113, the pressure in the intermediate gas storage 214I is preferably decreased, in particular to the (second) pressure level and/or the (target) pressure for the sensor apparatus 113.

When changing from the actuation of the sensor apparatus 113 to the actuation of the pump apparatus 112, the pressure in the intermediate gas storage 214I is preferably increased, in particular to the (first) pressure level and/or the (target) pressure for the pump apparatus 112.

Preferably, the pressure in the intermediate gas storage 214I is increased by fluidically connecting the intermediate gas storage 214I to the main gas storage 214C and/or the compressor 214B, in particular by activating the intermediate valve 290, the main valve 289 and/or the discharge valve 288, as already mentioned.

Preferably, the pressure in the intermediate gas storage 214I is reduced by fluidically connecting the intermediate gas storage 214I to an outlet of the pressurized gas supply 214 and/or an outlet silencer 214K, in particular by means of the first actuation valve 292 and/or the second actuation valve 293.

In the present embodiment, a pressure reduction can be achieved by activating the first actuation valve 292 and thereby fluidically connecting the intermediate gas storage 214I to an outlet of the pressurized gas supply 214 and/or an associated outlet silencer 214K.

The second actuation valve 293 is preferably fluidically connected to an outlet of the pressurized gas supply 214 and/or an associated outlet silencer 214K and/or fluidically connects the first actuation valve 292 to an outlet of the pressurized gas supply 214 and/or an associated outlet silencer 214K, when being unactuated/deactivated, as already mentioned. However, other solutions are possible as well.

When the pressure in the intermediate gas storage 214I has reached the pressure required for the actuation of the sensor apparatus 113, the intermediate gas storage 214I is preferably fluidically connected to the second connection element 214L and/or to the sensor apparatus 113, in particular by means of the second actuation valve 293 and/or the first actuation valve 292 which preferably fluidically connect(s) the second connection element 214L and/or the sensor apparatus 113 to the intermediate gas storage 214I.

Thus, the control apparatus 207, the intermediate valve 290, the throttle valve 291, the first actuation valve 292 and/or the second actuation valve 293 is/are preferably used to maintain a predefined pressure in the intermediate gas storage 214I for the operation of the pump apparatus 112 and/or the sensor apparatus 113 and, further, for adapting/changing the pressure in the intermediate gas storage 214I when another apparatus is to be activated and/or supplied with compressed air, e.g. when instead of the sensor apparatus 113 the pump apparatus 112 is to be operated/activated or vice versa.

According to a preferred method, the pump apparatus 112 and/or the sensor apparatus 113 are/is already fluidically connected to the intermediate gas storage 214I before the pressure in the intermediate gas storage 214I is changed, in particular increased, to the required/target pressure.

Preferably, before fluidically connecting the pump apparatus 112 and/or the sensor apparatus 113 to the intermediate gas storage 214I, the pressure in the intermediate gas storage 214I is optionally reduced to a predefined pressure, e.g. ambient pressure, in particular by means of the first actuation valve 292 and/or the second actuation valve 293.

Subsequently, the pump apparatus 112 and/or the sensor apparatus 113 are/is preferably fluidically connected to the intermediate gas storage 214I, in particular by activating or deactivating the first actuation valve 292 and/or the second actuation valve 293.

Subsequently, the pressure in the intermediate gas storage 214I is preferably increased, in particular by means of the intermediate valve 290, mostly preferred by activating the intermediate valve 290 and/or the throttle valve 291, in particular until the target pressure is reached.

Subsequently, the intermediate valve 290 is deactivated and/or the intermediate gas storage 214I is fluidically disconnected from the main gas storage 214C, in particular by deactivating the intermediate valve 290.

In this way, the pressure increase in the intermediate gas storage 214I corresponds to a pressure increase in the pump apparatus 112 and/or the sensor apparatus 113.

With other words, the pump apparatus 112 and/or the sensor apparatus 113 are/is preferably not suddenly/abruptly pressurized and/or powered with the target pressure, but rather gradually and/or simultaneously with the intermediate gas storage 214I, mostly preferred in a linear manner.

As already mentioned, the valve(s) 288-294, in particular the intermediate valve 290, the first actuation valve 292, the second actuation valve 293 and/or the third actuation valve(s) 294, is/are preferably embodied as solenoid valve(s) and/or comprise(s) an electric magnet as valve actuator 288A-294A.

The valve(s) 288-294, in particular the valve actuator(s) 288A-294A, is/are preferably operated with electrical energy.

Mostly preferred, the valve(s) 288-294, in particular the valve actuator(s) 288A-294A, generate(s) a magnetic field when being activated and/or in order to switch the valve position.

Preferably, the valve(s) 288-294 comprise(s) a core/plunger and/or a valve body, preferably wherein the core/plunger comprises or forms and/or is (rigidly) connected to the valve body.

Preferably, the core/plunger and/or valve body is (axially) movable relative to the valve actuator 288A-294A and/or within the housing of the valve(s) 288-294, in particular in order to change the valve position, mostly preferred from the initial position to the end position or vice versa and/or back and forth.

In particular, the core/plunger and/or the valve body is movable from the initial position to the end position or vice versa and/or back and forth in order to switch the fluid connections and/or to selectively fluidically connect or disconnect at least two ports of the valve 288-294 to or from one another, respectively.

Preferably, when the valve actuator 288A-294A is activated/energized/powered with electric energy, a magnetic field is generated and the core/plunger and/or the valve body is moved by means of the magnetic field, preferably in order to change the valve position and/or against the return mechanism 288B-294B.

In the initial position of the valve 288-294, the core/plunger and/or the valve body is preferably in a first/initial position and/or fluidically connects two ports of the valve 288-294 and/or fluidically disconnects two ports of the valves 288-294.

Preferably, the force exerted by means of the return mechanism 288B-294B on the core/plunger and/or the valve body is minimized in the initial position.

Preferably, the core/plunger and/or the valve body can be moved from the initial position to the end position, in particular by means of the valve actuator 288A-294A.

In the end position of the valve 288-294, the core/plunger and/or the valve body is preferably in a second/end position and/or fluidically connects or disconnects different ports of the valve 288-294 than in the initial position of the valve 288-294.

Preferably, the force exerted by means of the return mechanism 288B-294B on the core/plunger and/or the valve body is maximized in the end position.

FIG. 11 shows a schematic diagram of the electric current I used/consumed by a valve 288-294, in particular a valve actuator 288A-294A, when being activated/energized as a function of time.

FIG. 11 shows the complete switching operation, i.e. when the valve 288-294 or its valve body is switched completely and/or moved from the initial position to the end position. However, according to the present invention, the switching operation is preferably aborted before the valve 288-294 or its valve body is switched/moved completely and/or before it has reached the end position, as will be explained in the following. Thus, FIG. 11 does not correspond to the preferred operation of the valve 288-294.

The X-axis denotes the time T in seconds [s].

The Y-axis denotes the electric current I in amperes [A]. It starts with “0” which means that no current is consumed/used by the valve 288-294 or valve actuator 288A-294A.

Thus, it is preferred that in the initial position of the valve 288-294 and/or its valve body, the valve actuator 288A-294A is not supplied with electric energy and/or no electric current is consumed/used.

For the movement of the valve 288-294 and/or its valve body from the initial position to the end position, the valve 288-294 or valve actuator 288A-294A is energized and/or supplied with electric energy. However, it is also possible that in the initial position of the valve 288-294 and/or its valve body, the valve actuator 288A-294A is supplied with electric energy and/or electric current is consumed/used and that for the movement of the valve 288-294 and/or its valve body from the initial position to the end position, the valve 288-294 or valve actuator 288A-294A is de-energized and/or the power supply is cut off.

Preferably, the electric current I of and/or consumed by the valve(s) 288-294, in particular the intermediate valve 290, is measured, in particular for its operation, as will be explained in the following.

Here, this is explained exemplary for one valve 288-294, in particular the intermediate valve 290. However, the following description preferably applies to any of the vales 288-294 and/or FIG. 11 is representative for the temporal current progression for any of the valves 288-294.

As already mentioned, the valve 288-294 uses an electric current I to generate a magnetic field and/or to move the plunger/core and/or valve body, in particular from the initial position to the end position, and/or in order to change the valve position.

When being activated and/or when energizing the valve actuator 288A-294A and/or in order to generate the magnetic field, the current (consumption) of the valve 288-294, in particular the valve actuator 288A-294A, increases, in particular from 0 A, to the maximum current, in particular the end/third value I3, mostly preferred with a decreasing gradient.

The third current value I3 is preferably the maximum current and/or the highest value and/or the electric current used/consumed of the valve 288-294, in particular its valve actuator 288A-294A, when the switching operation is completed and/or when the valve 288-294, in particular its valve body, is in or has reached the end position.

With energizing the valve actuator 288A-294A and/or generating the magnetic field, a force is preferably exerted on the core/plunger and/or the valve body.

The force exerted by means of the magnetic field on the core/plunger and/or the valve body preferably increases with generating the magnetic field and/or with the current I.

When a certain value of the magnetic field, of the force and/or of the current I is reached, the core/plunger and/or the valve body starts to move, in particular out of its initial position, and/or the valve 288-294 starts to change its position.

With the movement of the core/plunger and/or the valve body relative to the valve actuator 288A-294A, an electromagnetic induction occurs and/or a (counter) current is preferably produced/induced, preferably until the core/plunger and/or the valve body stops to move and/or reaches its end position. This induced (counter) current preferably has an impact on the (measured) current I and/or its gradient.

Preferably, the current gradient is temporarily, i.e. between the time points T1 and T2, negative, due to the movement of the core/plunger and/or valve body.

In particular due to movement of the core/plunger and/or valve body, due to the electromagnetic induction and/or due to the (counter) current induction, the (positive) gradient of the current I is preferably (temporarily) reduced, in particular more/greater than without a counter current induction, and is temporarily negative, mostly preferred until the core/plunger and/or the valve body stops to move and/or reaches its end position.

Until a first current value I1 and/or a first time point T1 is reached, the current preferably increases and/or the current gradient is preferably positive.

The current increase is preferably stopped and/or the current gradient is zero at the first current value I1 and/or at a first time point T1, in particular due to movement of the core/plunger and/or valve body, due to the electromagnetic induction and/or due to the (counter) current induction.

Subsequently and/or until a second current value I2 and/or a second time point T2 is reached and/or until the core/plunger and/or the valve body stops to move and/or reaches its end position and/or between the first time point T1 and the second time point T2, the current preferably decreases and/or the current gradient is preferably negative.

The current decrease is preferably stopped and/or the current gradient is zero at the second current value I2 and/or at a second time point T2 and/or when the core/plunger and/or the valve body stops to move and/or reaches its end position.

Thus, the first current value I1 is preferably a (local) extremum (maximum), preferably wherein the first current value I1 indicates the movement of the core/plunger and/or valve body.

Thus, the first current value I1 and/or the first time point T1 can be used as an indicator for (the beginning of) the movement of the core/plunger and/or (the beginning of) the position change of the valve 288-294 (although the movement of the core/plunger preferably starts earlier, as already mentioned).

When the core/plunger and/or the valve body reaches its end position and/or stops to move and/or when the position change of the valve 288-294 is completed, the production/induction of the (counter) current and/or the current decrease is stopped and/or the current gradient is zero.

Preferably, the core/plunger and/or the valve body reaches its end position and/or stops to move and/or the position change of the valve 288-294 is completed at the second current value I2 and/or the second time point T2.

The second current value I2 is preferably a (local) extremum (minimum), preferably wherein the second current value I2 which indicates the end position of the core/plunger and/or the valve body and/or when the change of position is completed and/or when the core/plunger and/or the valve body stops to move.

The second current value I2 and/or the first time point T2 indicate(s) the end position of the core/plunger and/or the valve body and/or when the movement of the core/plunger and/or the valve body stops and/or when the core/plunger and/or the valve body reaches its end position and/or stops to move and/or if the position change of the valve 288-294 is completed.

Subsequently and/or after the time point T2 and/or after the valve 288-294 and/or the core/plunger and/or the valve body has reached its end position, no (counter) current is produced/induced and/or the current preferably increases (again) and/or the current gradient is preferably positive (again), in particular until the magnetic field is completely generated and/or the third value I3 is reached.

By measuring the current I of the valve 288-294, it is possible to detect/determine the first current value I1, the first time point T1, the second current value I2 and/or the second time point T2.

In particular, by measuring the current I of the valve 288-294, it is possible to detect/determine the reduction of the current gradient and/or when the current gradient is zero or becomes negative and/or when the valves 288-294 starts to change its position and/or when the core/plunger and/or the valve body starts to move and/or stops to move and/or reaches its end position.

In particular, the (local) maximum of the current I used/consumed by the valves 288-294, in particular for generating the magnetic field, is determined/detected in order to detect when the valve 288-294 starts to change its position and/or the core/plunger and/or the valve body starts to move.

Preferably, prior to the second time point T2, in particular at the first time point T1, and/or before the valve 288-294 reaches its end position and/or before the core/plunger and/or the valve body stops to move and/or during the switching operation and/or while the core/plunger and/or the valve body is still in motion, in particular at the first (local) maximum and/or when the valve 288-294 starts to change its position and/or the core/plunger and/or the valve body starts to move, the power supply is cut off and/or the valve 288-294 and/or its valve actuator 288A-294A is deactivated.

Subsequently and/or after the power supply is cut off and/or the valve 288-294 and/or its valve actuator 288A-294A is deactivated, the current decreases until zero (not shown) and/or the core/plunger and/or the valve body is moved back into its initial position, in particular by means of the return mechanism 288B-294B.

Thus, a further current consumption is prevented.

In this way, the switching time and/or the time of activation and, thus, the power consumption of the valve 288-294 operated in this manner can be reduced.

Further, the switching frequency can be increased, which, for example, allows to maintain the pressure in the intermediate gas storage 214I as stable as possible.

As already mentioned, this method is preferably used for the operation of the intermediate valve 290.

In order to increase the pressure in the intermediate gas storage 214I, the intermediate gas storage 214I is preferably fluidically connected to the main gas storage 214C and/or the compressor 214B, preferably by means of the intermediate valve 290, in particular by activating the intermediate valve 290.

In the initial position of the intermediate valve 290, the intermediate gas storage 214I is preferably fluidically disconnected from the main gas storage 214C and/or the compressor 214B.

The valve body of the intermediate valve 290 preferably fluidically disconnects the ports of the intermediate valve 290 that are connected to intermediate gas storage 214I and the main gas storage 214C, in the initial position of the intermediate valve 290 and/or when being deactivated/unactuated and/or de-energized.

When activating the intermediate valve 290 and/or energizing the valve actuator 290A, the valve body starts to move, as already explained.

With the movement of the valve body out of the initial position and, preferably, even before reaching the end position, a fluidic connection is preferably established between the intermediate gas storage 214I and the main gas storage 214C and/or the ports of the intermediate valve 290 that are connected to intermediate gas storage 214I and the main gas storage 214C.

Preferably, the intermediate valve 290, in particular the valve actuator 290A, is deactivated and/or de-energized before the valve body stops to move and/or reaches the end position and/or before the second time point T2.

Mostly preferred, the intermediate valve 290, in particular the valve actuator 290A, is deactivated and/or de-energized (immediately) after and/or when the valve body starts to move (out of its initial position), (immediately) after and/or when a counter current is induced, (immediately) after and/or when the current gradient is zero and/or negative and/or (immediately) after and/or when the intermediate gas storage 214I and the main gas storage 214 are fluidically connected to one another.

In particular, the intermediate valve 290, in particular the valve actuator 290A, is deactivated and/or de-energized at the first time point T1 and/or between the first time point T1 and the second time point T2.

Preferably, the first actuation valve 292 and/or the second actuation valve 293 can be operated in a similar manner, in particular in order to decrease the pressure in the intermediate gas storage 214I.

Preferably for the inspection of the analyzer 200, in particular the pressurized gas supply 214, mostly preferred the valve(s) 288-294, the actuator apparatuses 205B, the pump apparatus 112 and/or the sensor apparatus 113, the pressure drop and/or the air consumption associated with the operation of the valve(s) 288-294, the actuator apparatuses 205B, the pump apparatus 112 and/or the sensor apparatus 113 is measured and/or compared to values that correspond to the normal pressure drop.

For the inspection it is preferred to increase the pressure within the main gas storage 214C, in particular by means of the compressor 214B, preferably until a target/inspection pressure is reached, preferably in a first step.

Preferably, the compressor 214B is subsequently deactivated. With other words, the main gas storage 214C is preferably pressurized to the target/inspection pressure only once.

Subsequently and/or in a second step, the actuator apparatus 205B or at least one of the actuator apparatuses 205B is activated, in particular by means of the associated actuation valve 294, at least once, preferably repeatedly and/or several times.

Preferably, each actuation of the actuator apparatus 205B results in a corresponding pressure drop/loss and/or consumption of the pressure/air in the main gas storage 214C, preferably wherein the pressure drop/loss and/or consumption of the pressure/air in the main gas storage 214C is measured, in particular by means of the main pressure sensor 214H.

The measured pressure drop is preferably compared to a reference pressure drop, preferably by the control apparatus 207.

The reference pressure drops is preferably stored in a memory of the analyzer 200, in particular of the control apparatus 207.

The reference pressure drop preferably is the normal/expected pressure drop for the operation in question.

In case of a leakage, e.g. in the pneumatic line 214M between the actuator apparatus 205B and the main gas storage 214C, the pressure drop/air consumption is higher than normal.

In case the actuator apparatus 205B does not work properly, e.g. when its actuation element is jammed, the pressure drop and/or air consumption is lower than normal.

In case the associated actuation valve 294 does not work/switch properly, the pressure drop and/or air consumption is lower than normal and/or even lower than in case the actuator apparatus 205B does not work properly.

Thus, by measuring the pressure drop it is possible to detect whether the pneumatic lines 214M, the actuation valve(s) 294 and/or the actuator apparatus(es) 205B function properly.

In the same way, the pump apparatus 112, the sensor apparatus 113, the first actuation valve 292, the second actuation valve 293, the throttle valve 291 and/or the intermediate valve 290 can be inspected.

Following a test, the measurement results are read out electrically from the sensor apparatus 113 and processed either in the analyzer 200 or an external device (not shown).

Following the test, the used cartridge 100 is preferably ejected automatically, in particular my means of the lifting apparatus 238.

In particular, the intermediate unit 230, clamping unit 231 and/or the drive head 233E, and thus preferably also the cartridge 100, are/is moved back from the test position, in particular by means of the drive apparatus 233, in particular its drive 233A.

Subsequently, the analyzer 200 or the opening 213 opens. For this purpose, the access cover/housing port 212B is in particular moved by means of the opening apparatus 239.

The cartridge 100 can then be removed. In particular, the cartridge 100 is first ejected or moved out into the transfer position. This is carried out in particular by means of the lifting apparatus 238. The analyzer 200 is then (again) in the state shown in FIG. 7.

Finally, the used cartridge 100 can be manually removed from the transfer position and a new cartridge 100 (containing a new sample P) can be loaded for further testing.

If a new cartridge 100 has not been inserted or plugged in within a specified period of time, the analyzer 200 closes preferably automatically.

If a new cartridge 100 is inserted after the analyzer 200 has opened, the cartridge 100 is preferably moved automatically from the transfer position into the position in which it has been received in its entirety. For this purpose, the analyzer 200 preferably comprises a detection means for detecting whether a cartridge 100 has been received in part or inserted in part.

The analyzer 200 or the opening 213 closes in a preferably automatic manner and/or only if no object is present in the region of the opening 213. To this end, the analyzer 200 preferably comprises a detection means for detecting objects located in the region of the opening 213, in particular such that, if there is an object in this region, the device is automatically blocked or prevented from closing.

For reasons of safety, the analyzer 200 preferably is closed before the drive apparatus 233 is actuated and/or before the intermediate unit 230 is moved into the/test position and/or before the cartridge 100 is mounted, positioned and/or clamped.

Individual aspects and features of the present invention and individual method steps and/or method variants may be implemented independently from one another, but also in any desired combination and/or order.

In particular, the present invention relates also to any one of the following aspects which can be realized independently or in any combination, also in combination with any aspects described above or in the claims:

1. Analyzer 200 for testing an in particular biological sample P by means of a cartridge 100,
wherein the analyzer 200 comprises a pressurized gas supply 214,
wherein the pressurized gas supply 214 comprises a compressor 214B, a main gas storage 214C downstream of the compressor 214B, an intermediate valve 290 downstream of the main gas storage 214C and at least one actuation valve 292, 293, 294 downstream of the intermediate valve 290, and
wherein the analyzer 200 comprises an intermediate gas storage 214I, wherein the intermediate gas storage 214I is fluidically arranged between the intermediate valve 290 and the actuation valve 292, 293, 294.
2. Analyzer according to aspect 1, characterized in that the main gas storage 214C comprises a volume that is greater than the volume of the intermediate gas storage 214I.
3. Analyzer according to aspect 1 or 2, characterized in that the analyzer 200 comprises a main pressure sensor 214H for measuring the pressure in the main gas storage 214C and/or an intermediate pressure sensor 214J for measuring the pressure in the intermediate gas storage 214I.
4. Analyzer according to any of the preceding aspects, characterized in that the analyzer 200 comprises a connection unit 231 for pneumatically connecting the cartridge 100 to the pressurized gas supply 214.
5. Analyzer according to any of the preceding aspects, characterized in that the analyzer 200, in particular the connection unit 231, comprises at least one connection element 214A, 214L to pneumatically connect the analyzer 200, in particular the pressurized gas supply 214, to the cartridge 100, wherein the connection element 214A, 214L is fluidically arranged downstream of the actuation valve 292, 293, 294 and/or forms an outlet of the pressurized gas supply 214.
6. Analyzer according to any of the preceding aspects, characterized in that the analyzer 200 comprises at least one pneumatically operated actuator 205B for mechanically actuating an associated valve 115B on the cartridge 100, wherein the actuator 205B is fluidically arranged in parallel to the intermediate gas storage 214I.
7. Analyzer according to any of the preceding aspects, characterized in that the intermediate valve 290 and/or the actuation valve 292, 293, 294 is constructed as a solenoid valve and/or—in particular 3/2—directional control valve.
8. Method for testing an in particular biological sample P in an analyzer 200 by means of a cartridge 100,
wherein at least one apparatus 112, 113, 205B for controlling the fluid flow in the cartridge 100 is pneumatically operated,
wherein the apparatus 112, 113, 205B is supplied with pressurized gas by means of a pressurized gas supply 214 having a compressor 214B, a main gas storage 214C downstream of the compressor 214B and an intermediate valve 290 downstream of the main gas storage 214C,
characterized
in that the intermediate valve 290 is embodied as a solenoid valve, wherein the intermediate valve 290 is activated or deactivated before it has reached its end position, and/or in that the pressure of an intermediate gas storage 214I located downstream of the intermediate valve 290 is controlled.
9. Method according to aspect 8, characterized in that the current of the intermediate valve 290 is measured in order to determine when the position of the intermediate valve 290 starts to change and/or when a valve body of the intermediate valve 290 start to move.
10. Method according to aspect 8 or 9, characterized in that a change in the current gradient of the intermediate valve 290, in particular a local extremum of the current, is determined in order to activate or deactivate the intermediate valve 290 and/or in order to determine when the position of the intermediate valve 290 starts to change and/or when a valve body of the intermediate valve 290 starts to move.
11. Method according to any of the aspects 8 to 10, characterized in that the apparatus 112, 113 is arranged within the cartridge 100.
12. Method according to any of the aspects 8 to 11, characterized in that a plurality of apparatuses 112, 113, 205B is pneumatically operated by means of the pressurized gas supply 214, in particular the intermediate gas storage 214I, wherein one of the plurality of apparatuses 112, 113, 205B is embodied as a pump apparatus 112 for conveying a fluid and/or one of the plurality of apparatuses 112, 113, 205B is embodied as a sensor apparatus 113 for detecting an analyte of the sample P.
13. Method according to any of the aspects 8 to 12, characterized in that the cartridge 100 is received by the analyzer 200 and mechanically, electrically, thermally and/or fluidically coupled to the analyzer 200 in order to carry out the test.
14. Method for inspecting an analyzer 200, wherein the analyzer 200 is adapted to test an in particular biological sample P by means of a cartridge 100,
wherein at least one apparatus 112, 113, 205B for controlling the fluid flow in the cartridge 100 is pneumatically operated,
wherein the apparatus 112, 113, 205B is supplied with pressurized gas by means of a pressurized gas supply 214 having a compressor 214B and a main gas storage 214C downstream of the compressor 214B, and
wherein the pressure drop associated with the operation of the apparatus 112, 113, 205B is measured in order to inspect the analyzer 200.
15. Method according to any of the aspects 8 to 14, characterized in that the analyzer 200 is constructed according to any of the aspects 1 to 7.

### LIST OF REFERENCE SIGNS

100 cartridge
100A front
100B back
101 main body
101E depression
102 cover
103 fluid system
104 receiving cavity
105 metering cavity
106 intermediate cavity
107 mixing cavity
108 storage cavity
109 reaction cavity
110 intermediate temperature control cavity
111 collection cavity
112 pump apparatus
113 sensor apparatus
113E contact
113H central region
114 channel
115 valve
115A initially closed valve
115B initially/normally open valve
116 sensor portion
121 edge
122 reinforcing rib
123 grip portion
126 positioning portion
129 connection
130 closure element
200 analyzer
201 receptacle
202 pump drive
202A motor
202B pump head
203 connection apparatus
203A contact element
204 temperature-control apparatus
204A reaction temperature-control apparatus
204B intermediate temperature-control apparatus
204C sensor temperature-control apparatus
205 actuator apparatus
205A actuator apparatus for 115A
205B actuator apparatus for 115B
206 sensor
206A fluid sensor
206B other sensor
207 control apparatus
208 input apparatus
209 display apparatus
210 interface
211 power supply
211A connection
212 housing
212A interior space
212B access cover/housing part
212C base
212D top
213 opening
214 pressurized gas supply
214A first connection element
214B compressor
214C main gas storage
214D inlet
214E filter
214F inlet silencer
214G inlet gas storage
214H main pressure sensor
214I intermediate gas storage
214J intermediate pressure sensor
214K outlet silencer
214L second connection element
214M pneumatic line
230 receiving/intermediate unit
231 connection unit
231A bearing portion
231B support region
231C engagement portion
231D main body
232 clamping unit
233 drive apparatus
233A drive
233D shaft
233E drive head
234 guide apparatus
234A first guide
234B second guide
234C first rail
234D second rail
234E main bush
237 (mounting) rack
237A mounting surface
238 lifting apparatus
238B retaining element
239 opening apparatus
239A drive
239C support
239D shaft
280 clamping system
281 ventilation apparatus
282 electronic unit
283 cushion
283A base
283B top
283D interior
284 first coupling
285 second coupling
286 detection apparatus
288 discharge valve
288A valve actuator
288B return mechanism
289A valve actuator
289B return mechanism
289 main valve
290 intermediate valve
290A valve actuator
290B return mechanism
291 throttle valve
292 first actuation valve
292A valve actuator
292B return mechanism
293 second actuation valve
293A valve actuator
293B return mechanism
294 third actuation valve
294A valve actuator
294B return mechanism
AG1 first guide axis
AG2 second guide axis
AA actuation axis
I electric current
I1 first current value
I2 second current value
I3 third current value
F liquid reagent
H main plane of cartridge
P sample
S dry reagent
T time
T1 first time point
T2 second time point

1. An analyzer for testing a biological sample by means of a cartridge, the analyzer comprising:
a pressurized gas supply having a compressor, a main gas storage downstream of the compressor, an intermediate valve downstream of the main gas storage and at least one actuation valve downstream of the intermediate valve, or
an intermediate gas storage, wherein the intermediate gas storage is fluidically arranged between the intermediate valve and the actuation valve.

2. The analyzer according to claim 1, wherein the main gas storage has a volume that is greater than the volume of the intermediate gas storage.

3. The analyzer according to claim 1, further comprising a main pressure sensor for measuring the pressure in the main gas storage and an intermediate pressure sensor for measuring the pressure in the intermediate gas storage.

4. The analyzer according to claim 1, further comprising a connection unit having at least one connection element for pneumatically connecting the cartridge to the pressurized gas supply, wherein the connection element is fluidically arranged downstream of the actuation valve and forms an outlet of the pressurized gas supply.

5. The analyzer according to claim 4, wherein the connection element protrudes out of the connection unit.

6. The analyzer according to claim 4, wherein the connection unit comprises a plurality of connection elements to pneumatically connect different apparatuses of the cartridge to the pressurized gas supply independently of one another.

7. The analyzer according to claim 1, wherein the pressurized gas supply comprises a plurality of actuation valves.

8. The analyzer according to claim 6, wherein the pressurized gas supply comprises a plurality of actuation valves and wherein each connection element is arranged downstream of a respective one of the actuation valves.

9. The analyzer according to claim 1, further comprising at least one pneumatically operated actuator for mechanically actuating an associated valve on the cartridge, wherein the actuator is fluidically arranged in parallel to the intermediate gas storage.

10. The analyzer according to claim 1, wherein the pressurized gas supply comprises an actuation valve that is fluidically arranged in parallel to the intermediate gas storage and is adapted to selectively fluidically connect and disconnect the actuator to and from the main gas storage.

11. The analyzer according to claim 1, wherein the intermediate valve and the actuation valve are constructed as at least one of a solenoid valve and a directional control valve.

12. A method for testing a biological sample in an analyzer by means of a cartridge, including:
controlling a fluid flow in a cartridge by at least one apparatus which is pneumatically operated; and
supplying the at least one apparatus with a pressurized gas from a pressurized gas supply having a compressor, wherein a main gas storage is downstream of the compressor and an intermediate valve is downstream of the main gas storage,
with at least one of the following features:
the intermediate valve is embodied as a solenoid valve, wherein the intermediate valve is activated or deactivated before it has reached its end position; or
a plurality of apparatuses is pneumatically operated by means of the pressurized gas supply, wherein a pressure of an intermediate gas storage located downstream of the intermediate valve is adapted depending on an apparatus of the plurality of apparatuses to be activated or deactivated.

13. The method according to claim 12, wherein a current of the intermediate valve is measured in order to determine when a valve body of the intermediate valve starts to move.

14. The method according to claim 12, wherein a change in a current gradient of the intermediate valve is determined in order to activate or deactivate the intermediate valve.

15. The method according to claim 12, wherein the apparatuses are arranged within the cartridge.

16. The method according to claim 12, wherein one of the plurality of apparatuses is embodied as a pump apparatus for conveying a fluid.

17. The method according to claim 12, wherein one of the plurality of apparatuses is embodied as a sensor apparatus for detecting an analyte of the sample.

18. The method according to claim 12, wherein the cartridge is received by the analyzer and is at least one of mechanically, electrically, thermally and fluidically coupled to the analyzer in order to carry out a test.

19. Method for inspecting an analyzer that is configured to test a biological sample by means of a cartridge, including:
controlling a fluid flow in the cartridge by at least one apparatus which is pneumatically operated; and
supplying the at least one apparatus with a pressurized gas from a pressurized gas supply having a compressor and a main gas storage downstream of the compressor, and
measuring a pressure drop associated with an operation of the at least one apparatus in order to inspect the analyzer.
